(19) United States
(12) Patent Application Publication
(10) Pub. No.: US 2010/0183202 A1
(43) Pub. Date: Jul. 22, 2010

(54) BRAIN-IMAGE DIAGNOSIS SUPPORTING METHOD, PROGRAM, AND RECORDING MEDIUM

(75) Inventors: Yoshitake Takahashi, Tokyo (JP); Tatsuya Takagi, Osaka (JP); Kousuke Okamoto, Osaka (JP); Masafumi Harada, Tokushima (JP)

Correspondence Address: MILES & STOCKBRIDGE PC, 1751 PINNACLE DRIVE, SUITE 500, MCLEAN, VA, 22102-3833, US

(73) Assignees: FUJIFILM RI PHARMA CO., LTD., Tokyo (JP); Osaka University, Osaka (JP); The University of Tokushima, Tokushima (JP)

(21) Appl. No.: 12/513,842

(22) PCT Filed: Nov. 5, 2007
(86) PCT No.: PCT/JP2007/071509

§ 371 Date: Apr. 1, 2010

(30) Foreign Application Priority Data
Nov. 6, 2006 (JP) 2006-301001

(51) Int. Cl. G06K 9/00

(52) U.S. Cl. 382/128

(57) ABSTRACT

To provide a brain-image diagnosis supporting method or the like. The method is a statistical evaluation method excluding the subjective judgment of an examiner, and enables image diagnosis. The method can present stable judgment criteria with respect to data on brain images imaged by a predetermined method in order to discriminate difficult diseases to diagnose. The method is also effective with respect to relationships which can not be always explained with a simple linear relationship, for example, the relationship between data on brain images imaged by a predetermined method and a disease which is a variable. By applying a predetermined nonlinear multivariate analysis method to data on brain images of a plurality of examinees imaged by a predetermined method and by classifying the data, image diagnosis support using a computer performed with respect to the data on brain images is performed. For example, SOM method is applied as a predetermined nonlinear multivariate analysis method. Data on brain images of a plurality of examinees imaged by SPECT or the like are handled as input data vectors x, which are presented to neurons on a two-dimensional lattice array in the SOM method so as to perform image diagnosis support based on the two-dimensional SOM after a predetermined training length.

### TECHNICAL FIELD

The present invention relates to a brain-image diagnosis supporting method using a computer performed with respect to data on brain images.

### BACKGROUND ART

In order to diagnose diseases with varying regional cerebral blood flow (rCBF) such as Alzheimer's disease (AD), nuclear medicine image diagnosis methods such as Single Photon Emission Computed Tomography (SPECT) and Positron Emission Tomography (PET) are used. By these methods, a patients is administered with a radioactive agent, from which gamma ray is emitted. The gamma ray is utilized to measure accumulation status in the brain and then to demonstrate in a form of a tomographic image brain functions such as cerebral blood flow and/or receptor distribution as well as glucose and/or oxygen metabolism.

In the aforementioned conventional nuclear medicine image diagnosis method, since a doctor (examiner) visually diagnoses the image based on his/her experience, the impression given to the examiner depends on image displaying status, and correct diagnosis ratio depends on the experience of the examiner. Even if the same examiner diagnoses the same image, there is a problem with reproducibility. In addition, it is difficult to spot a slight change in the blood flow. Therefore, statistical evaluation methods excluding the subjective judgment of the examiner have been developed in recent years. (See Non-Patent References 1 through 6).

In the aforementioned nuclear medicine image diagnosis methods such as SPECT (SPECT on cerebral blood flow) and PET, as well as image diagnosis methods such as magnetic resonance imaging (MRI) method and nuclear magnetic resonance imaging apparatus, a measured image of the patients is evaluated visually by a doctor. When a method such as 3D-SSP (three-dimensional stereotactic surface projections) is used, an abnormal site of the patients compared to a healthy person is apparently shown in the brain image. Even in this case, however, only the abnormal site compared with a standard data is shown in the brain image, so that a doctor anyway evaluates depending on his experience which abnormal site is related to which disease. Therefore, various multivariate analysis methods have been applied for the purpose of diagnosing stably and trying to discriminate difficult diseases to diagnose. In Non-Patent Reference 7, for example, a linear discriminant analysis is applied, while neural network method with backpropagation type is applied in Non-Patent Reference 8.

Non-Patent Reference 1: Minoshima S, Foster N L, Kuhl D E. Posterior cingulated cortex in Alzheimer's disease. Lancet. 1994; 344: 895.
Non-Patent Reference 2: Burdette J H, Minoshima S, Borght T V, Tran D D, Kuhl D E. Alzheimer disease: improved visual interpretation of PET images by three-dimensional stereotaxic surface projections. Radiology. 1996; 198: 837-843.
Non-Patent Reference 3: Minoshima S, Giordani B, Berent S, Frey K A, Foster N L, Kuhl D E. Metabolic reduction in the posterior cingulate cortex in very early Alzheimer's disease. Ann Neurol. 1997; 42: 85-94.
Non-Patent Reference 4: Ishii K, Sasaki M, Yamaji S, Sakamoto S, Kitagaki H, Mori E. Demonstration of decreased posterior cingulated gyrus correlates with disorientation for time and place in Alzheimer's disease by means of H₂¹⁵O positron emission tomography. Eur J Nucl Med. 1997; 24: 670-673.
Non-Patent Reference 5: Kogure D, Matsuda H, Ohnishi T, Asada T, Uno M, Kunihiro T, Nakano S, Takasaki M. Longitudinal evaluation of early Alzheimer's disease using brain perfusion SPECT. J Nucl Med. 2000; 41: 1155-1162.
Non-Patent Reference 6: Ishii K, Sasaki M, Matsui M, Sakamoto S, Yamaji S, Hayashi N, Mori T, Kitagaki H, Hirono N, Mori E. A diagnostic method for suspected Alzheimer's disease using H₂¹⁵O positron emission tomography perfusion Z-score. Neuroradiology. 2000; 42: 787-794.
Non-Patent Reference 7: P Charpentier, I Lavenu, L Defebvre, A Duhamel, P Lecouffe, F Pasquier, M Steinling. Alzheimer's disease and frontotemporal dementia are differentiated by discriminant analysis applied to ^{99m}Tc HmPAO SPECT data. J Neurol Neurosurg Psychiatry; 69:661-663: 2000
Non-Patent Reference 8: Rui J. P. DEFIGUEIREDO, W. RODMAN SHANKLE, ANDREA MACCATO, MALCOLM B. DICK, PRASHANTH MUNDKUR, ISMAEL MENA, AND CARL W. COTMAN. Neural-network-based classification of cognitively normal, demented, Alzheimer disease and vascular dementia from single photon emission with computed tomography image data from brain. Proc. Natl. Acad. Sci. USA: 92: 5530-5534: June: 1995

### DISCLOSURE OF INVENTION

### Problem to be Solved by the Invention

As shown in Non-Patent References 1 through 6, though statistical evaluation methods excluding the subjective judgment of an examiner have been developed in recent years, these statistical evaluation methods are regarded to be testing procedures for watching varying blood flow, but not to be an image diagnosis method, which is a problem. There is also another problem, i.e., since cerebral blood flow varies depending on age, sex and progression of a disease, it is difficult in usual image diagnosis methods to find relationships between it and each disease for the purpose of discriminating difficult diseases to diagnose, so that a stable judgment criterion cannot be presented with respect to an identical SPECT result of cerebral blood flow. In multivariate analysis methods shown in Non-Patent Reference 7 or the like, a linear relationship is used, but the relationship between SPECT images of the cerebral blood flow and a disease, which is a variable, cannot be always explained with a simple linear relationship, which is still another problem.

Therefore, the present invention has been achieved to solve the above-described problems, and it is an object of the present invention to provide a brain-image diagnosis supporting method or the like. The method is a statistical evaluation method excluding the subjective judgment of an examiner, and enables image diagnosis.

The second object of the present invention is to provide a brain-image diagnosis supporting method or the like which can present stable judgment criteria with respect to SPECT result of cerebral blood flow imaged by a predetermined method such as cerebral blood flow SPECT in order to discriminate difficult diseases to diagnose.

The third object of the present invention is to provide an brain-image diagnosis supporting method or the like which are also effective with respect to relationships which can not be always explained with a simple linear relationship, for example, the relationship between SPECT images of cerebral blood flow imaged by a predetermined method such as cerebral blood flow SPECT and a disease which is a variable.

### Means for Solving Problem

A brain-image diagnosis supporting method of the present invention is a brain-image diagnosis supporting method using a computer performed with respect to data on brain images, wherein Self-Organizing Map (SOM) method is applied to data on brain images of a plurality of examinees imaged by a predetermined method so as to classify said data for said image diagnosis support; said data on brain images of the plurality of examinees imaged by said predetermined method are presented as input data vectors to neurons on a two-dimensional lattice array of the SOM method so as to perform image diagnosis support based on two-dimensional SOM after a predetermined training length; regarding said SOM, a measure to be minimum between said input data vector and a reference vector of each neuron is Euclidean distance; and a neighborhood function which is used for learning said reference vector is a monotone decreasing function with respect to training length, which has a characteristic to converge on 0 with said training length being infinite, to monotonically decrease with respect to the Euclidean distance to a winner neuron, and to have an extent of said monotone decreasing being larger with the increase in training length.

Here, in the brain-image diagnosis supporting method of the present invention, the method further may comprise: an acquisition step of all lattice values where values of all lattices of said two-dimensional SOM are evaluated for each learning by each input data vector; a degree acquisition step where, based on all lattice values of said two-dimensional SOM for each input data vector evaluated in said acquisition step of all lattice values, a degree on similarity or dissimilarity between each of said input data vectors is evaluated; and a constellation step where multidimensional scaling method is applied to said degree between each of said input data vector evaluated in said degree acquisition step so as to evaluate a point on a two-dimensional plane satisfying the degree between each of said input data vector.

Here, in the brain-image diagnosis supporting method of the present invention, wherein said value of the lattice of said two-dimensional SOM may be a distance with weight evaluated based on a predetermined distance between said input data vector and said reference vector.

A brain-image diagnosis supporting method of the present invention is a brain-image diagnosis supporting method using a computer performed with respect to data on brain images, wherein Kernel principal component analysis (PCA) method is applied to data on brain images of a plurality of examinees imaged by a predetermined method so as to classify said data for image diagnosis support; said data on brain images of the plurality of examinees imaged by said predetermined method are handled as an object to be analyzed for said Kernel PCA method; said data are mapped to a high-dimensional feature space by means of a kernel trick using a predetermined kernel function; and said data are subject to linear principal component analysis in said high-dimensional feature space so as to perform nonlinear principal component analysis.

A brain-image diagnosis supporting method of the present invention is a brain-image diagnosis supporting method using a computer performed with respect to data on brain images, wherein nonlinear support vector machine (SVM) method is applied to data on brain images of a plurality of examinees imaged by a predetermined method so as to classify said data for image diagnosis support; said data on brain images of the plurality of examinees imaged by said predetermined method are handled as an object to be analyzed for said nonlinear SVM method; said data are mapped to a high-dimensional feature space by means of a kernel trick using a predetermined kernel function; and said data are subject to linear SVM method in said high-dimensional feature space so as to perform nonlinear discrimination.

A brain-image diagnosis supporting method of the present invention is a brain-image diagnosis supporting method using a computer performed with respect to data on brain images, wherein Kernel Fisher discriminant analysis method is applied to data on brain images of a plurality of examinees imaged by a predetermined method so as to classify said data for image diagnosis support; said data on brain images of the plurality of examinees imaged by said predetermined method are handled as an object to be analyzed for Kernel Fisher discriminant analysis; said data are mapped to a high-dimensional feature space by means of a kernel trick using a predetermined kernel function; said data are subject to linear discriminant analysis in said high-dimensional feature space so as to perform nonlinear discrimination; and in said linear discriminant analysis method, weight in a discriminant function used for classifying a piece of data in either of the groups is evaluated by maximizing an objective function expressed as a ratio between the between-groups sum of squares and within-groups sum of squares.

Here, in the brain-image diagnosis supporting method of the present invention, wherein said objective function may be rewritten in a predetermined Equation so as to allow discrimination with a probability that a piece of data belongs to a certain group.

Here, in the brain-image diagnosis supporting method of the present invention, wherein a Gaussian kernel or a polynomial kernel may be used as said predetermined kernel function.

Here, in the brain-image diagnosis supporting method of the present invention, wherein as said brain-image data, data on brain image on lattice points which are selected by a predetermined selection method from data on all imaged brain images on all lattice points may be used.

Here, in the brain-image diagnosis supporting method of the present invention, wherein said predetermined selection method may comprise: a standardization step, where said data on imaged brain images on all lattice points is standardized, independent of disease, to a predetermined mean and predetermined variance on all lattice points; an acquisition step of standard data, where with respect to said data on brain images on all lattice points standardized in said standardization step, averaging is performed for each lattice point for each disease so as to make standard data at each lattice point for each disease; an acquisition step of the absolute value of difference, where for each combination of two diseases, absolute values of the differences of the standard data for each diseases obtained at each lattice point in said acquisition step of standard data are evaluated; and a selection step, where lattice points are selected starting from the lattice point with the largest absolute value of difference evaluated in said acquisition step of the absolute value of difference until achieving a predetermined ratio of the number of all lattice points.

Here, in the brain-image diagnosis supporting method of the present invention, wherein said brain-image data may be obtained from examinees suffering from degenerative neurological disorder as target group.

Here, in the brain-image diagnosis supporting method of the present invention, wherein said predetermined method for imaging said brain-image data may be Single Photon Emission Computed Tomography (SPECT).

A brain-image diagnosis supporting program of the present invention is a brain-image diagnosis supporting program which allows a computer to perform a brain-image diagnosis support with respect to data on brain images, wherein Self-Organizing Map (SOM) method is applied to data on brain images of a plurality of examinees imaged by a predetermined method so as to classify said data for said image diagnosis support; said data on brain images of the plurality of examinees imaged by said predetermined method are presented as input data vectors to neurons on a two-dimensional lattice array of the SOM method so as to perform image diagnosis support based on two-dimensional SOM after a predetermined training length; regarding said SOM, a measure to be minimum between said input data vector and a reference vector of each neuron is Euclidean distance; and a neighborhood function which is used for learning said reference vector is a monotone decreasing function with respect to training length, which has a characteristic to converge on 0 with said training length being infinite, to monotonically decrease with respect to the Euclidean distance to a winner neuron, and to have an extent of said monotone decreasing being larger with the increase in training length.

Here, in the brain-image diagnosis supporting program of the present invention, the program may further comprise: an acquisition step of all lattice values where values of all lattices of said two-dimensional SOM are evaluated for each learning by each input data vector; a degree acquisition step where, based on all lattice values of said two-dimensional SOM for each input data vector evaluated in said acquisition step of all lattice values, a degree on similarity or dissimilarity between each of said input data vectors is evaluated; and a constellation step where multidimensional scaling method is applied to said degree between each of said input data vector evaluated in said degree acquisition step so as to evaluate a point on a two-dimensional plane satisfying the degree between each of said input data vector.

Here, in the brain-image diagnosis supporting program of the present invention, wherein said value of the lattice of said two-dimensional SOM may be a distance with weight evaluated based on a predetermined distance between said input data vector and said reference vector.

A brain-image diagnosis supporting program of the present invention is a brain-image diagnosis supporting program which allows a computer to perform a brain-image diagnosis support with respect to data on brain images, wherein Kernel principal component analysis (PCA) method is applied to data on brain images of a plurality of examinees imaged by a predetermined method so as to classify said data for image diagnosis support; said data on brain images of the plurality of examinees imaged by said predetermined method are handled as an object to be analyzed for said Kernel PCA method; said data are mapped to a high-dimensional feature space by means of a kernel trick using a predetermined kernel function; and said data are subject to linear principal component analysis in said high-dimensional feature space so as to perform nonlinear principal component analysis.

A brain-image diagnosis supporting program of the present invention is a brain-image diagnosis supporting program which allows a computer to perform a brain-image diagnosis support with respect to data on brain images, wherein nonlinear support vector machine (SVM) method is applied to data on brain images of a plurality of examinees imaged by a predetermined method so as to classify said data for image diagnosis support; said data on brain images of the plurality of examinees imaged by said predetermined method are handled as an object to be analyzed for said nonlinear SVM method; said data are mapped to a high-dimensional feature space by means of a kernel trick using a predetermined kernel function; and said data are subject to linear SVM method in said high-dimensional feature space so as to perform nonlinear discrimination.

A brain-image diagnosis supporting program of the present invention is a brain-image diagnosis supporting program which allows a computer to perform a brain-image diagnosis support with respect to data on brain images, wherein Kernel Fisher discriminant analysis method is applied to data on brain images of a plurality of examinees imaged by a predetermined method so as to classify said data for image diagnosis support; said data on brain images of the plurality of examinees imaged by said predetermined method are handled as an object to be analyzed for Kernel Fisher discriminant analysis; said data are mapped to a high-dimensional feature space by means of a kernel trick using a predetermined kernel function; said data are subject to linear discriminant analysis in said high-dimensional feature space so as to perform nonlinear discrimination; and in said linear discriminant analysis method, weight in a discriminant function used for classifying a piece of data in either of the groups is evaluated by maximizing an objective function expressed as a ratio between the between-groups sum of squares and within-groups sum of squares.

Here, in the brain-image diagnosis supporting program of the present invention, wherein said objective function may be rewritten in a predetermined Equation so as to allow discrimination with a probability that a piece of data belongs to a certain group.

Here, in the brain-image diagnosis supporting program of the present invention, wherein a Gaussian kernel or a polynomial kernel may be used as said predetermined kernel function.

Here, in the brain-image diagnosis supporting program of the present invention, wherein as said brain-image data, data on brain image on lattice points which are selected by a predetermined selection method from data on all imaged brain images on all lattice points may be used.

Here, in the brain-image diagnosis supporting program of the present invention, wherein said predetermined selection method may comprise: a standardization step, where said data on imaged brain images on all lattice points is standardized, independent of disease, to a predetermined mean and predetermined variance on all lattice points; an acquisition step of standard data, where with respect to said data on brain images on all lattice points standardized in said standardization step, averaging is performed for each lattice point for each disease so as to make standard data at each lattice point for each disease; an acquisition step of the absolute value of difference, where for each combination of two diseases, absolute values of the differences of the standard data for each diseases obtained at each lattice point in said acquisition step of standard data are evaluated; and a selection step, where lattice points are selected starting from the lattice point with the largest absolute value of difference evaluated in said acquisition step of the absolute value of difference until achieving a predetermined ratio of the number of all lattice points.

Here, in the brain-image diagnosis supporting program of the present invention, wherein said brain-image data may be obtained from examinees suffering from degenerative neurological disorder as target group.

Here, in the brain-image diagnosis supporting program of the present invention, wherein said predetermined method for imaging said brain-image data may be Single Photon Emission Computed Tomography (SPECT).

A computer-readable recording medium of the present invention is a computer-readable recording medium that records the brain-image diagnosis supporting program of any one of the present invention.

### EFFECT OF THE INVENTION

In accordance with a brain-image diagnosis supporting method or the like of the present invention, by applying a predetermined nonlinear multivariate analysis method to data on brain images of a plurality of examinees imaged by a predetermined method and by classifying the data, image diagnosis support using a computer performed with respect to the data on brain images can be performed. For example, Kohonen type neural network method (SOM method) is applied as a predetermined nonlinear multivariate analysis method. Data on brain images of a plurality of examinees imaged by a predetermined method such as SPECT are handled as input data vectors x, which are presented to neurons on a two-dimensional lattice array in the SOM method so as to perform image diagnosis support based on the two-dimensional SOM after a predetermined training length. Here, a measure to be minimum between an input data vector x(t) and a reference vector ω_{i,j} (t−1) of each neuron u_{i,j} is Euclidean distance. Neighborhood function h which is used for learning the reference vector ω_{i,j} (t−1) is a monotone decreasing function with respect to t (training length). It has a characteristic to converge on 0 with t being infinite, to monotonically decrease with respect to Euclidean distance ∥u_{i,j}−u_{I,j}∥ between a lattice point (i,j) and a lattice point (I,J) where a winner neuron u_{I,J} is located, and to have an extent of monotonically decreasing being larger with the increase in t. Since the method classifies data by applying a predetermined nonlinear multivariate analysis method it is possible, as mentioned above, to provide a brain-image diagnosis supporting method or the like which are a statistical evaluation method or the like excluding the subjective judgment of an examiner, and which enable image diagnosis. In addition, it is possible in discriminating difficult diseases to diagnose to present stable judgment criteria with respect to SPECT result of cerebral blood flow imaged by a predetermined method such as cerebral blood flow SPECT. As the method classifies data by applying a predetermined nonlinear multivariate analysis method, it has an effect to provide an brain-image diagnosis supporting method or the like which are also effective with respect to relationships which can not be always explained with a simple linear relationship, for example, the relationship between SPECT images of cerebral blood flow imaged by a predetermined method such as cerebral blood flow SPECT and a disease which is a variable.

### BRIEF DESCRIPTION OF THE DRAWINGS

FIG. 1 is a flow chart schematically illustrating a brain-image diagnosis supporting method or the like using a computer performed with respect to data on brain images according to the present invention.

FIG. 2 shows a two-dimensional SOM 10 applied to Embodiment 1 of the present invention.

FIG. 3 is a flow chart showing an algorithm used in the two-dimensional SOM 10.

FIG. 4 schematically shows fingerprint verification type SOM applied in Embodiment 2 according to the present invention.

FIG. 5 is a flow chart showing a process flow of the fingerprint verification type SOM.

FIG. 6 schematically shows Kernel PCA method in Embodiment 3 according to the present invention.

FIG. 7 schematically shows nonlinear SVM method in Embodiment 4 according to the present invention.

FIG. 8 schematically shows Kernel Fisher discriminant analysis in Embodiment 5 according to the present invention.

FIG. 9 is a block diagram showing an internal circuit 50 of the computer executing a brain-image diagnosis supporting program according to the present invention.

FIG. 10 is a flow-chart showing a flow of input data selection method in accordance with Embodiment 7 of the present invention.

FIG. 11 is a schematic graph for describing the input data selection method.

FIG. 12 is a schematic graph for describing the input data selection method.

FIG. 13 shows a result of SOM when selected coordinate 1 was used.

FIG. 14 shows a result of Fingerprint verification type SOM when selected coordinate 1 was used.

FIG. 15 shows a result of Kernel PCA when selected coordinate 1 was used.

FIG. 16 shows a result of Kernel PCA when selected coordinate 1 was used.

FIG. 17 shows a result of SOM when selected coordinate 2 was used.

FIG. 18 shows a result of Fingerprint verification type SOM when selected coordinate 2 was used.

FIG. 19 shows a result of Kernel PCA when selected coordinate 2 was used.

FIG. 20 shows a result of SVM when selected coordinate 1 was used.

FIG. 21 shows a result of Kernel Fisher discriminant analysis when selected coordinate 1 was used.

FIG. 22 shows a result of Kernel Fisher discriminant analysis when selected coordinate 1 was used.

FIG. 23 shows a result of SVM when selected coordinate 2 was used.

FIG. 24 shows a result of Kernel Fisher discriminant analysis when selected coordinate 2 was used.

FIG. 25 shows a result of Kernel Fisher discriminant analysis when selected coordinate 2 was used.

FIG. 26 shows a concept of fingerprint verification type SOM.

FIG. 27 shows an example of discrimination by fingerprint verification type SOM in Embodiment 8.

FIG. 28 is a view illustrating probabilistic discrimination from unsupervised learning.

### EXPLANATIONS OF LETTERS OR NUMERALS

2 data on brain images, 4 a predetermined nonlinear multivariate analysis, 6,20 classified results, 10 a two-dimensional SOM, 12 an input layer, 14 an input data vector of pattern A, 16 an input data vector of pattern B, 18 a competitive layer, 30 a decision surface, 32 a support vector, 40 a between-groups sum of squares, 42a,42b a within-groups sum of squares, 50 an internal circuit, 51 C P U, 52 ROM, 53 RAM, 54 display device, 55 VRAM, 56 an image control unit, 57 a controller, 58a a disk, 58n CD-ROM, 59 an input control unit, 60 an input operation unit, 61 an external IN, 62 a bus.

### BEST MODE(S) FOR CARRYING OUT THE INVENTION

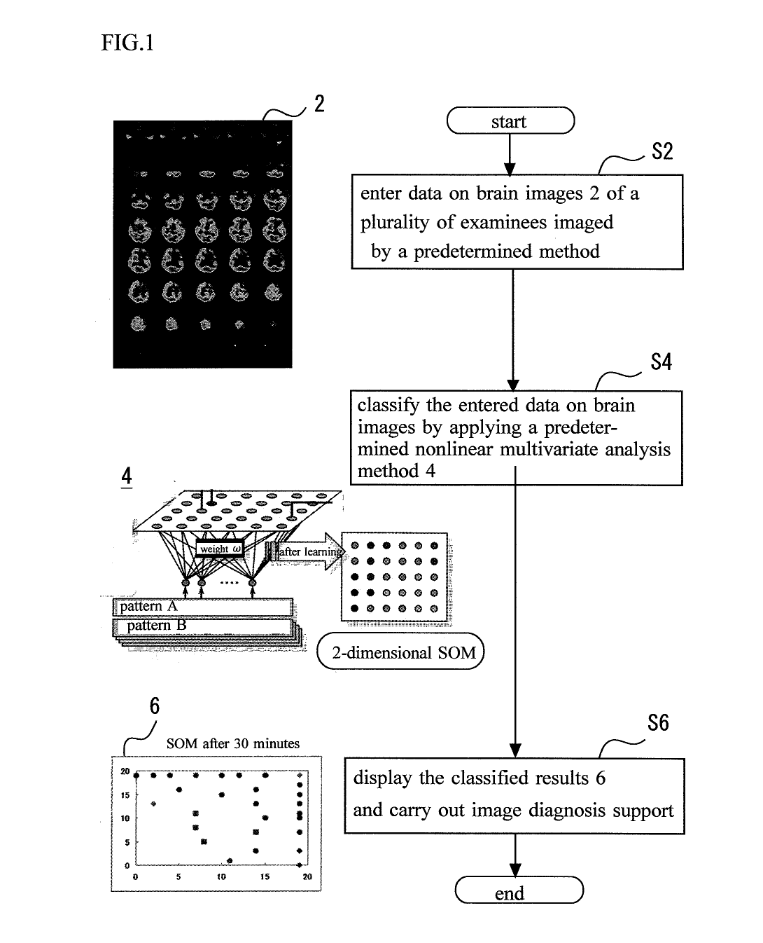

First, the present invention is schematically illustrated. FIG. 1 is a flow chart schematically illustrating a brain-image diagnosis supporting method or the like using a computer performed with respect to data on brain images according to the present invention. As shown in FIG. 1, data on brain images 2 of a plurality of examinees imaged by a predetermined method are entered (Step S2). Then, the entered data on brain images 2 are classified by applying a predetermined nonlinear multivariate analysis method 4 (Step S4). By displaying the classified results 6, image diagnosis support is carried out (Step S6). As a predetermined method for imaging data on brain images 2, cerebral blood flow SPECT is preferably used, though the predetermined method for imaging is not limited to cerebral blood flow SPECT, but may of course be PET, MRI or Computer Tomography (CT). Hereinafter, for the sake of convenience in the explanation, cerebral blood flow SPECT is used as the predetermined method in this explanation. As examinees, examinees suffering from degenerative neurological disorders are preferable. As degenerative neurological disorders, Alzheimer's disease, Parkinson's disease, dementia with Lewy body, Huntington's Chorea, progressive supranuclear palsy or the like can be mentioned for example. As a predetermined nonlinear multivariate analysis method, Kohonen type neural network method (Self-organizing Map method (SOM)), fingerprint verification type SOM developed by the inventors of the present invention, Kernel principal component analysis (PCA) method, nonlinear support vector machine (SVM) method and Kernel Fisher discriminant analysis method are preferably used. Other nonlinear multivariate analysis methods may be used. Hereinafter, each of the examples applying the above-mentioned predetermined nonlinear multivariate analysis method as well as the out line of each nonlinear multivariate analysis methods are explained in detail in reference to the drawings. The applying results to the data of cerebral blood flow SPECT are collectively shown at the end of this document.

### Embodiment 1

In Embodiment 1, Kohonen type neural network method (SOM method) was applied as a predetermined nonlinear multivariate analysis method. First, SOM method is described schematically.

Kohonen type neural network method was announced by T. Kohonen in 1981. It is a neural network method of unsupervised leafing, and is also called as Self-organizing map (SOM), (T. Kohonen. Self-organizing Maps. Springer-Verlag, Heidelberg, 1995.) where a capability for classifying a group of entered patterns depending on their similarity is acquired autonomously. SOM is one of the hierarchical neural network methods. As a learning rule, competitive learning is used. When a piece of data is entered from an input layer, a neuron best capturing its characteristics is fired in a competition layer. By repeatedly entering various patterns, similar patterns fire neurons being located near each other, while dissimilar patterns fire neurons being located far each other, so that connection weight ω varies. After sufficient learning, connection weight ω is converged on a certain value. At this moment, the firing mapping of input pattern groups on the competition layer reflects similarity of the patterns, so that it is used as a result of the classification. In general, two-dimensional SOM which maps n-dimensional input data groups into a two-dimensional alignment is used.

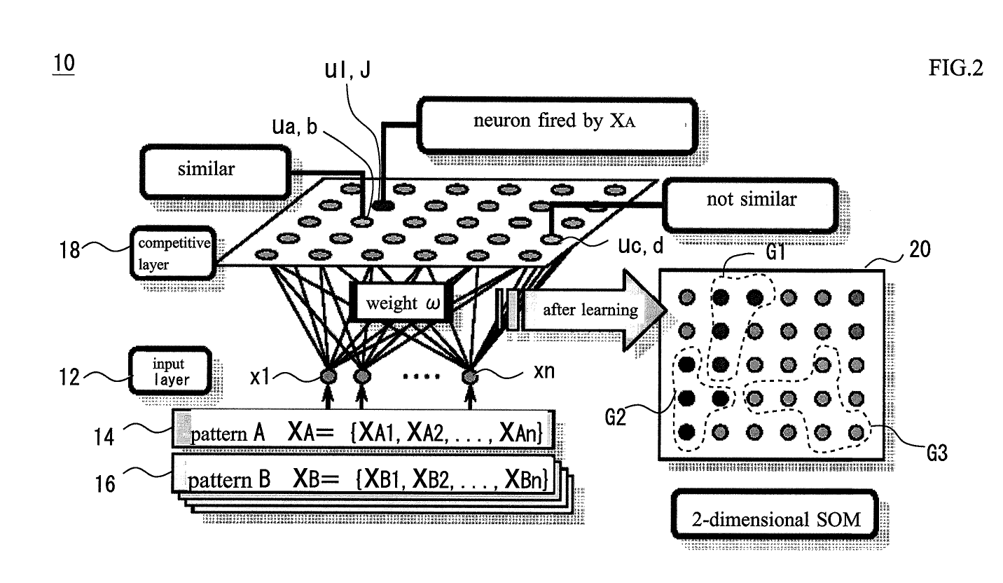

Next, applying SOM method to data on brain images of a plurality of examinees imaged by a predetermined method such as SPECT is described. FIG. 2 shows a two-dimensional SOM 10 applied to Embodiment 1 of the present invention. In FIG. 2 reference numeral 12 denotes a n-dimensional input layer x(t), where t denotes time 0, 1, 2 . . . , and each x(t) is an input data vector having n pieces of input data at time t. In FIG. 2, time t is omitted, and each element of the input data vectors x(t) is denoted as x₁, . . . , xₙ. In other words, each input data is given by n-dimensional real number vector x=(x₁, . . . , xₙ). Reference numeral 14 is an input data vector x_{A}={x_{A1}, x_{A2}, . . . , x_{An}} of pattern A, while reference numeral 16 is an input data vector x_{B}={x_{B1}, x_{B2}, . . . , x_{Bn}} of pattern B. Reference numeral 18 denotes a two-dimensionally aligned competitive layer, which has vertically five and horizontally six, i.e., in total 30 neurons (or units) in FIG. 2. But the neuron number of the two dimensional SOM applied to Embodiment 1 of the present invention is not limited to 30. Here, a two-dimensional SOM is shown from a visual aspect, though the SOM applied to Embodiment 1 of the present invention is not limited to a two-dimensional one. Hereinafter, the two-dimensional SOM is supposed to have neurons u_{i,j} (i, j=1˜m) arranged on a m×m lattice points. The input data vector x is presented to every neuron u_{i,j}, and the neuron u_{i,j} which is located on the two-dimensional lattice array (i,j) has variable connection weight ω_{i,j}=(ω_{ij,1}, ω_{ij,2}, . . . , ω_{ij,n}) corresponding to the input data vector x, where i and j are 1 through m, respectively. (In FIG. 2, it is denoted as weight ω.) This ω_{i,j} is referred to as reference vector. The reference vector is denoted as ω_{i,j} (t), though the time t is omitted in FIG. 2.

Computation is performed by the following procedures: Each of data on brain images of a plurality of examinees imaged by a predetermined method such as SPECT is handled as an input data vector x presented to neurons on the SOM two-dimensional lattice array, so that image diagnosis support is performed based on the two-dimensional SOM after a predetermined training length. As is shown in FIG. 2, with a pattern A (input data vector x_{A}) being entered, neuron u_{I,J} (winner neuron) is fired. Subsequently, when a pattern B (input data vector x_{B}) is entered, a neuron u_{a,b} in the vicinity of the u_{I,j} is fired when the pattern B is similar to the input data vector x_{A}, and neuron u_{c,d} being located far from the u_{I,j} is fired when the pattern B is not similar to the input data vector x_{A}.

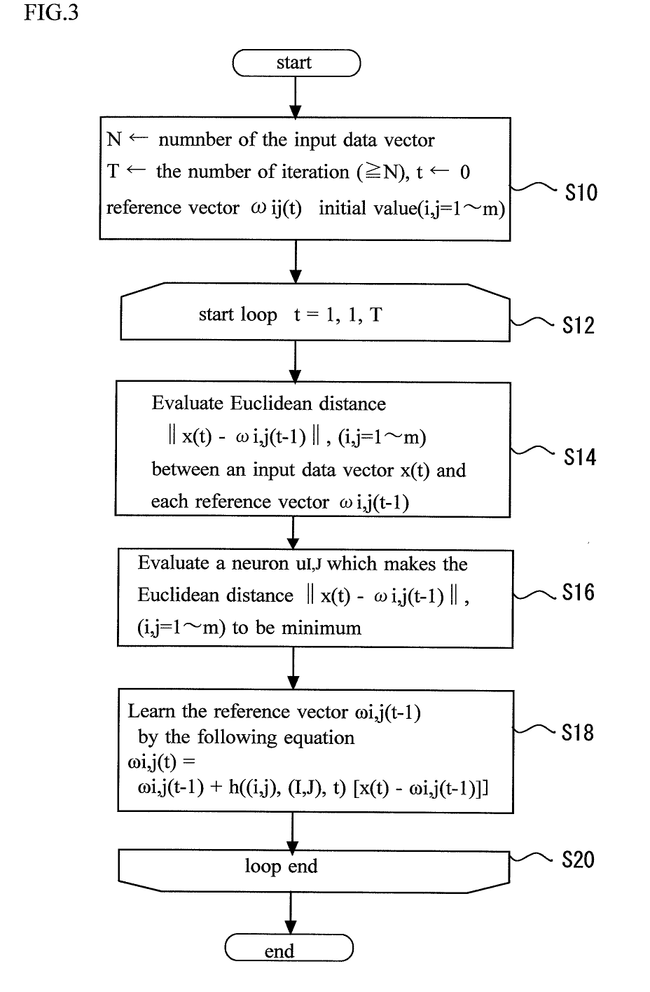

Next, an algorithm used for the two-dimensional SOM 10 is described. FIG. 3 is a flow chart showing an algorithm used in the two-dimensional SOM 10. Hereinafter, both FIGS. 2 and 3 are used for explanation. As shown in FIG. 3, number of the input data vector x(t) is given as N, the number of iteration is given as T(≧N), and t is set as t=0. An initial value of reference vector ω_{i,j} (t) is given randomly, where t=0 and i,j are i,j=1 through m (Step S10).

To t=1, 2, . . . , T, the following operations (Steps S14 through S18) are repeated (Steps S12 and S20).

Euclidean distance ∥x(t)−ω_{i,j} (t−1)∥ between an input data vector x(t) and each reference vector ω_{i,j} (t−1), where i,j=1 through m, is evaluated (Step S14).

A neuron u_{I,J}, which makes the Euclidean distance (i,j=1 through m) evaluated in Step S14 to be minimum is evaluated (Step S16). In other words, a measure to be minimum between the input data vector x(t) and the reference vector ω_{i,j} (t−1) of each neuron u_{i,j} is the Euclidean distance.

Reference vector ω_{i,j} (t) is learned by the following Equation 1 (Step S18):

[Numerical formula 1]

ω_{i,j}(t)=ω_{i,j}(t−1)+h{(i,j),(I,J),t}{x(t)−ω_{i,j}(t−1)} (1)

Here, h is a function called as neighborhood function which is used for learning the reference vector ω_{i,j} (t) and has the following characteristics.

1. It is a monotone decreasing function with respect to t (training length). It converges on 0 with t being infinite.
2. It monotonically decreases with respect to Euclidean distance ∥u_{i,j}−u_{I,J}∥ between a lattice point (i,j) and a lattice point (I,J) where a winner neuron u_{I,J} is located. The extent of monotonic decrease becomes larger with the increase in t.

In Step S18, the fired neuron u_{I,J} revises weight ω_{i,j} (t) so as to improve response to the identical input vector x_{S} in the next cycle. All neurons u_{a,b} or the like near the neuron u_{I,j} are revised with respect to their weight ω_{a,b}(t) with an amount which decreases as the Euclidean distance to the neuron u_{I,J} increases. In other words, learning is performed such that neurons u_{a,b} or the like located more nearly to the fired neuron u_{I,J} are more influenced by the firing.

After learning is completed at Step S20, classification result 20 is obtained as shown in FIG. 2. As shown in the classification result 20, those being similar to input data vector x_{A} are classified in group G1, while those being similar to another input data vector x_{B} are classified in group G2 or the like. As mentioned above, by plotting the location of a winner neuron, classification can be performed.

In SOM, not the entire network performs learning with respect to the presented data, but the neuron u_{I,J} near the data and the neuron u_{a,b} or the like near the neuron u_{I,J} selectively learn with respect to their connection weight ω_{i,j} (t). This type of learning method is called as competitive learning. The number of iteration T means training length to be performed, and needs to be set as a parameter in advance. If the number of iteration T is too large, overfitting is caused where neural network having been already learned is made to learn again, resulting in a vicious circle. If it is too small, on the other word, the learning may be ended before it is sufficiently performed. Therefore, the number of iteration T is set to be a desired value where no overfitting is caused and at the same sufficient learning can be performed. As a SOM program, som_pak3.1 (http://www.cis.hut.fi/research/som-research/nnrc-programs.shtml), which Kohonen, the developer, himself prepared, was used.

As mentioned above, in accordance with Embodiment 1 of the present invention, by applying a predetermined nonlinear multivariate analysis method to data on brain images of a plurality of examinees imaged by a predetermined method and by classifying the data, image diagnosis support using a computer performed with respect to the data on brain images can be performed. Kohonen type neural network method (SOM method) is applied as a predetermined nonlinear multivariate analysis method. Data on brain images of a plurality of examinees imaged by a predetermined method such as SPECT are handled as input data vectors x, which are presented to neurons on a two-dimensional lattice array in the SOM method so as to perform image diagnosis support based on the two-dimensional SOM after a predetermined training length. Here, a measure to be minimum between an input data vector x(t) and a reference vector ω_{i,j} (t−1) of each neuron u_{i,j} is Euclidean distance. Neighborhood function h which is used for learning the reference vector ω_{i,j} (t) is a monotone decreasing function with respect to t (training length). It has a characteristic to converge on 0 with t being infinite, to monotonically decrease with respect to Euclidean distance ∥u_{i,j}−u_{I,J} ∥ between a lattice point (i,j) and a lattice point (I,J) where a winner neuron u_{I,J} is located, and to have an extent of monotonically decreasing being larger with the increase in t.

As mentioned above, since the method classifies data by applying a predetermined nonlinear multivariate analysis method it is possible to provide a brain-image diagnosis supporting method or the like which are a statistical evaluation method or the like excluding the subjective judgment of an examiner, and which enable image diagnosis. In addition, it is possible, in discriminating difficult diseases to diagnose, to present stable judgment criteria with respect to SPECT result of cerebral blood flow imaged by a predetermined method such as cerebral blood flow SPECT. As the method classifies data by applying a predetermined nonlinear multivariate analysis method, it is possible to provide an brain-image diagnosis supporting method or the like which are also effective with respect to relationships which can not be always explained with a simple linear relationship, for example, the relationship between SPECT images of cerebral blood flow imaged by a predetermined method such as cerebral blood flow SPECT and a disease which is a variable.

### Embodiment 2

In Embodiment 2, fingerprint verification type SOM developed by the inventors was applied as a predetermined nonlinear multivariate analysis. First, fingerprint verification type SOM is described schematically.

As mentioned above, SOM usually is used as a classification method by plotting a position of a winner neuron u_{I,J}. On the other hand, there is some value on every output lattice of SOM. From the view point of effectively utilizing information, it is preferable to utilize data not only of the winner neuron u_{I,J}, (and the neurons nearby) but also data of every neuron. For this purpose, the inventors examined a method of utilization of fingerprint verification type, which is like fingerprint verification, where all values on every output lattice of SOM are utilized (fingerprint verification type SOM).

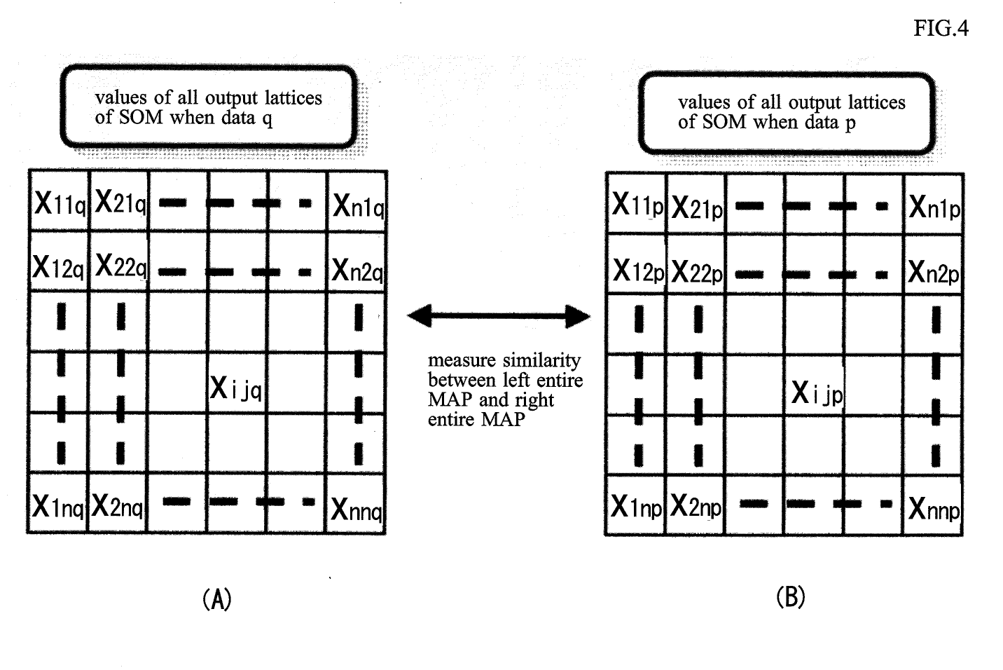

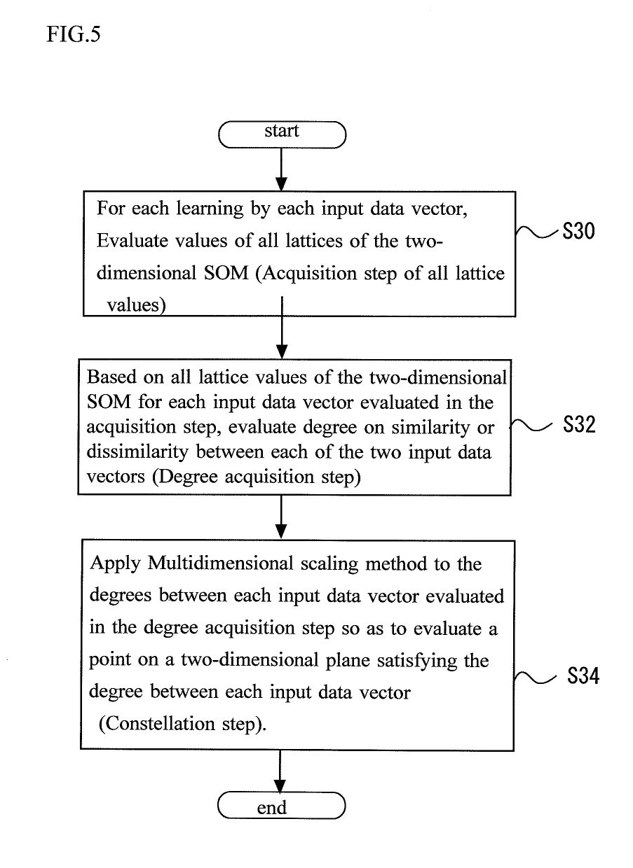

Next, it is explained how to apply fingerprint verification type SOM to data on brain images of a plurality of examinees imaged by a predetermined method such as SPECT. FIG. 4 schematically shows fingerprint verification type SOM applied in Embodiment 2 according to the present invention, while FIG. 5 is a flow chart showing a process flow of the fingerprint verification type SOM. Hereinafter, description is made in reference to FIGS. 4 and 5. As shown in FIG. 5, for each learning by each input data vector in response to the above-mentioned data on brain images, values of all lattices of the two-dimensional SOM are evaluated (Acquisition step of all lattice values, Step S30). Specifically, values of all output lattices of SOM xᵢⱼₖ (i, j=1˜n) are evaluated for each sample input vector xₖ (k=1, 2, . . . , m). FIG. 4(A) shows values of all output lattices x_{ijq} (i, j=1˜n) of SOM when a piece of sample data x_{q} is entered. FIG. 4(B) shows values of all output lattices x_{ijq}(i, j=1˜n) of SOM when a piece of sample data xₚ is entered.

Based on all lattice values of the two-dimensional SOM for each input data vector evaluated in the acquisition step of all lattice values (Step S30), degree on similarity or dissimilarity between each of the two input data vectors is evaluated (Degree acquisition step, S22). In other words, similarity (or dissimilarity) between the entire MAP with respect to the sample input data vector x_{q} as shown in FIG. 4(A) and the entire MAP with respect to the sample input data vector xₚ as shown in FIG. 4(B) is measured. As a degree, matrix V_{pq} (p, q=1˜mₒ p and q differ from each other) showing similarity (or dissimilarity) between the sample q and sample p as shown in equation 2 can be used. The value of the matrix V_{pq} is small when the sample data are similar each other, while it is larger when the sample data are different from each other, so that the matrix V_{pq} can be called as distance matrix.

$$\begin{matrix}[ Numerical formula 2 ] & \\ {V}_{pq} = \frac{1}{{n}^{2}} \sqrt{{\sum }_{i = 1}^{n} {\sum }_{j = 1}^{n} {( {x}_{ijp} - {x}_{ijq } )}^{2}} & ( 2 )\end{matrix}$$

Multidimensional scaling method is applied to the degrees (distance matrix Vpqₒp, q=1˜m. p and q are different each other) between each input data vector evaluated in the degree acquisition step (Step S32) so as to evaluate a point on a two-dimensional plane satisfying the degree between each input data vector (Constellation step, Step S34). As mentioned above, Euclidean distance was used in the present application as similarity (or dissimilarity) matrix V_{pq}. As a program for the multidimensional scaling method, Proxscal of SPSS (trademark) 13.0.1 was used.

As mentioned above, in Embodiment 2 of the present invention, unlike in Embodiment 1, fingerprint verification type SOM which the inventors have developed was applied as a predetermined nonlinear multivariate analysis method. First, for each learning by each input data vector, values of all lattices of the two-dimensional SOM are evaluated (Acquisition step of all lattice values). Then, based on all lattice values of the two-dimensional SOM for each input data vector evaluated in the acquisition step of all lattice values, degree indicating similarity or dissimilarity between each of the input data vectors is evaluated (Degree acquisition step). As the degree, Euclidean distance was used. Multidimensional scaling method was applied to the degrees (distance matrix Vpqₒp, q=1˜m. p and q are different each other) between each input data vector evaluated in the degree acquisition step so as to evaluate a point on a two-dimensional plane satisfying the degree between each input data vector (Constellation step).

As mentioned above, since classification is performed by applying a predetermined nonlinear multivariate analysis method in a case of Embodiment 2 like in Embodiment 1, it is possible to provide a brain-image diagnosis supporting method or the like which are a statistical evaluation method or the like excluding the subjective judgment of an examiner, and which enable image diagnosis. In addition, it is possible in discriminating difficult diseases to diagnose to present stable judgment criteria with respect to SPECT result of cerebral blood flow imaged by a predetermined method such as cerebral blood flow SPECT. As the method classifies data by applying a predetermined nonlinear multivariate analysis method, it is possible to provide an brain-image diagnosis supporting method or the like which are also effective with respect to relationships which can not be always explained with a simple linear relationship, for example, the relationship between SPECT images of cerebral blood flow imaged by a predetermined method such as cerebral blood flow SPECT and a disease which is a variable.

### Embodiment 3

In Embodiment 3, Kernel principal component analysis (PCA) method was applied as a predetermined nonlinear multivariate analysis. First, Kernel PCA method is described schematically.

Kernel PCA method is a nonlinear principal component analysis method announced by B. Scholkopf in 1988 (B. Sch&ouml;lkopf. A. Smola. K. M&uuml;ller. Nonlinear Component Analysis as a Kernel Eigenvalue Problem. Neural Computation: 10: 1299-1319: 1998. “Frontier of Statistical Science 6: Statistics on Pattern Recognition and Learning”, by Hideki ASO et al., Iwanami Shoten (2003)). In the linear principal component analysis a principal component Z can be evaluated from an eigenvector A, which has been evaluated by solving eigenvalue problems of variance-covariance matrix in a data matrix X, and the data matrix X, as shown in the following Equation 3.

[Numerical formula 3]

Z=AX (3)

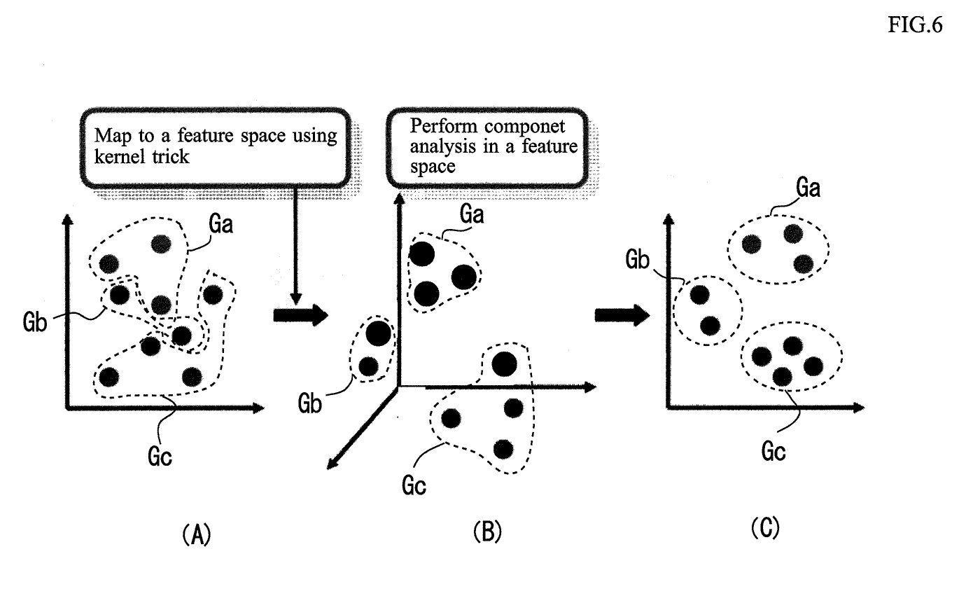

Next, it is explained how to apply Kernel PCA method to data on brain images of a plurality of examinees imaged by a predetermined method such as SPECT. FIG. 6 schematically shows Kernel PCA method in Embodiment 3 according to the present invention. In a two-dimensional space shown in FIG. 6(A), linear principal component analysis cannot be performed with respect to groups Ga, Gb and Gc. Therefore, data on brain images of a plurality of examinees imaged by a predetermined method such as SPECT are mapped to a three-dimensional space as shown in FIG. 6(B) (in general, high-dimensional feature space, or sometimes infinite-dimensional space, Hilbert space) η so as to perform linear principal component analysis in η. Subsequently, by mapping to the original space (two-dimensional space) again as shown in FIG. 6(C), nonlinear principal component analysis is realized. Since directly mapping data to the high-dimensional feature space η is difficult, analysis in the high-dimensional feature space η is realized using a method called kernel trick.

A kernel trick is not a method that data is directly mapped when data is mapped to the high-dimensional feature space η so as to apply a linear model f(x) in the high-dimensional feature space η, but is a method to avoid difficulties in computation by evaluating inner products of the data in the high-dimensional feature space η, by using a kernel function K=k(x,y). The kernel function is defined by the following two definitions (Equations 4 and 5) and needs to satisfy the following Mercer's theorem (Equations M1 and M2).

Definition 1: The kernel function has symmetry as shown in Equation 4.

[Numerical formula 4]

k(x,y)=k(y,x) (4)

Definition 2: The following Equation 5 is satisfied with respect to arbitrary N>1, arbitrary x₁, . . . , x_{N} (where each of them is an element of the entire object set X (input space)), that is the kernel function is positive semidefinite. (R is a real space.)

$$\begin{matrix}[ Numerical formula 5 ] & \\ {\sum }_{i , j} {c}_{i} {c}_{j} k ( {x}_{i} , {x}_{j} ) ≧ 0 \\ ∀ {c}_{1} , … , {c}_{N} ε R \\ {x}_{1} , {x}_{2} , … , {x}_{N} ε X & ( 5 )\end{matrix}$$

From Definitions 1 and 2, there is a mapping (Equation M1) satisfying Equation M2 with respect to arbitrary Mercer kernel K (Mercer's theorem).

$$\begin{matrix}( Equation 6 ) & \\ Φ ( x ) := {\{ {φ}_{k} ( x ) \}}_{K = 1}^{D} & ( M1 ) \\ K ( {x}_{i} , {x}_{j} ) = {\sum }_{K = 1}^{D} {φ}_{k} ( {x}_{i} ) {φ}_{k} ( {x}_{j} ) & ( M2 )\end{matrix}$$

As shown in Equation 6 satisfying the above-mentioned Mercer's theorem, a kernel function shows an inner product of data vector in the high-dimensional feature space η mapped by Φ.

[Numerical formula 7]

k(xᵢ,xⱼ)=Φ(xᵢ)·Φ(xⱼ (6)

It is considered to express a linear model in the high-dimensional feature space using a kernel function. First, a linear model f(x,θ) in a usual space is expressed as shown in Equation 7 by using weight vector o and bias b (where d is a number of dimensions of the input space in Equation 7). Then, the weight vector ω can be expressed using a factor vector α as linear coupling of data vector x as shown in Equation 8.

$$\begin{matrix}[ Numerical formula 8 ] & \\ f ( x , θ ) = {ω}^{T} x + b , θ = \{ ω , b \} , ωε {R}^{d} , b ε R & ( 7 ) \\ ω = {\sum }_{i = 1}^{n} {α}_{i} {x}_{i} & ( 8 )\end{matrix}$$

Here, the linear model f(x) can be expressed as an inner product of data vectors x and xi, as shown in Equation 9.

$$\begin{matrix}[ Numerical formula 9 ] & \\ f ( x ) = {\sum }_{i = 1}^{n} {α}_{i} {x}^{T} {x}_{i} & ( 9 )\end{matrix}$$

Similarly, the weight vector ω and the linear model f(Φ(x)) in high-dimensional feature space η can be expressed as shown in Equations 10 and 11.

$$\begin{matrix}[ Numerical formula 10 ] & \\ ω = {\sum }_{i = 1}^{n} {α}_{i} Φ ( {x}_{i} ) & ( 10 ) \\ [ Numerical formula 11 ] & \\ f ( Φ ( x ) ) = {\sum }_{i = 1}^{n} {α}_{i} {Φ ( x )}^{T} Φ ( {x}_{i} ) & ( 11 )\end{matrix}$$

Therefore, by using a kernel function, the linear model in the high-dimensional feature space η can be expressed by a kernel function, as shown in Equation 12. This is a kernel trick.

$$\begin{matrix}[ Numerical formula 12 ] & \\ f ( Φ ( x ) ) = {\sum }_{i = 1}^{n} {α}_{i} K ( x , {x}_{i} ) & ( 12 )\end{matrix}$$

As a major kernel function, a Gaussian kernel as shown in Equation 13 or a polynomial kernel as shown in Equation 14 can be used.

$$\begin{matrix}[ Numerial formula 13 ] & \\ Gaussian kernel \\ k ( x , y ) = exp ( - \frac{{‖ x - y ‖}^{2}}{2 {σ}^{2}} ) & ( 13 )\end{matrix}$$

[Numerical formula 14] polynomial kernel

k(x,y)=(ax^{T}y+1)^{b} (14)

Next, an algorithm of kernel PCA is described. Variance-covariance matrix V with respect to data xᵢ (i=1, 2, . . . , M) in the high-dimensional feature space η mapped by Φ is expressed in Equation 15.

$$\begin{matrix}[ Numerical formula 15 ] & \\ V = \frac{1}{M} {\sum }_{i = 1}^{M} Φ ( {x}_{i} ) {Φ ( {x}_{i} )}^{T} & ( 15 )\end{matrix}$$

When eigenvalue and eigenvector of V are given as λ and ω, respectively, Eigenvalue problem is set as shown in Equation 16.

[Numerical formula 16]

Vω=λω (16)

Here, as shown in Equation 17,

$$\begin{matrix}Equation 17 ] & \\ ω = {\sum }_{i = 1}^{M} {α}_{i} Φ ( {x}_{i} ) & ( 17 )\end{matrix}$$

where a factor α is given, the Eigenvalue problem can be written using a kernel matrix K with respect to data xi, as shown in Equation 18.

[Numerical formula 18]

Kα=Mλα (18)

Principal component Z can be given as shown in Equation 19.

$$\begin{matrix}[ Numerical formula 19 ] & \\ Z = ( ω \cdot Φ ( x ) ) \\ = {\sum }_{i = 1}^{M} {α}_{i} k ( {x}_{i} , x ) & ( 19 )\end{matrix}$$

As a program for kernel PCA, Gist2.2 (http://microarray.cpmc.columbia.edu/gist/index.html) was used, and a generally available Gaussian kernel was used as a kernel function.

As described above, in Embodiment 3 of the present invention, unlike in Embodiment 1 or the like, kernel PCA method was applied as a predetermined nonlinear multivariate analysis. In other words, data on brain images of a plurality of examinees imaged by a predetermined method such as SPECT are mapped to a high-dimensional feature space η by a kernel trick using a predetermined function so as to perform linear principal component analysis in η. Subsequently, by mapping to the original space again, nonlinear principal component analysis is realized.

As mentioned above, since classification is performed by applying a predetermined nonlinear multivariate analysis method in a case of Embodiment 3 like in Embodiment 1, it is possible to provide a brain-image diagnosis supporting method or the like which are a statistical evaluation method or the like excluding the subjective judgment of an examiner, and which enable image diagnosis. In addition, it is possible in discriminating difficult diseases to diagnose to present stable judgment criteria with respect to SPECT result of cerebral blood flow imaged by a predetermined method such as cerebral blood flow SPECT. As the method classifies data by applying a predetermined nonlinear multivariate analysis method, it is possible to provide an brain-image diagnosis supporting method or the like which are also effective with respect to relationships which can not be always explained with a simple linear relationship, for example, the relationship between SPECT images of cerebral blood flow imaged by a predetermined method such as cerebral blood flow SPECT and a disease which is a variable.

### Embodiment 4

In Embodiment 4, nonlinear support vector machine (SVM) method was applied as a predetermined nonlinear multivariate analysis. First, nonlinear SVM method is described schematically.

SVM method is a pattern classification method with a teacher used to classify two groups, and was proposed by V. N. Vapnik et al. in 1995 (“Frontier of Statistical Science 6: Statistics on Pattern Recognition and Learning”, by Hideki ASO et al., Iwanami Shoten (2003), and V. Vapnik “The Nature of Statistical Learning Theory”, Springer, N.Y., 1995). With the linear SVM, two groups of data which have labels of either 1 or −1 are separated by a straight line or a hyperplane, while with the nonlinear SVM, a nonlinear discrimination is performed by performing liner SVM in a high-dimensional feature space η using the above-mentioned kernel trick.

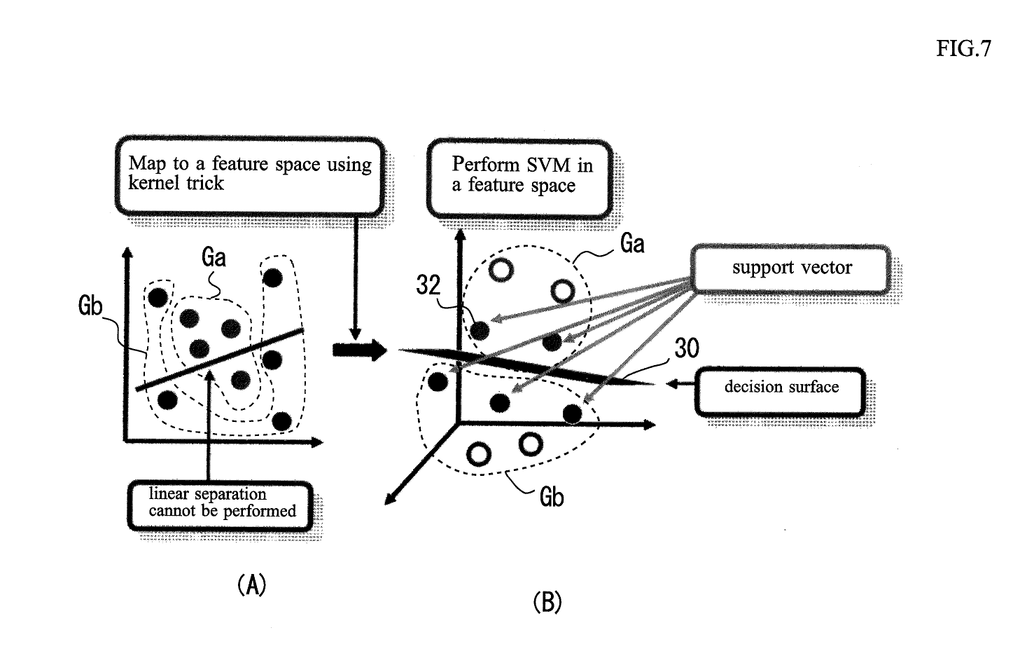

Next, it is explained how to apply nonlinear SVM method to data on brain images of a plurality of examinees imaged by a predetermined method such as SPECT. FIG. 7 schematically shows nonlinear SVM method in Embodiment 4 according to the present invention. In a two-dimensional space shown in FIG. 7(A), linear separation (linear SVM) cannot be performed with respect to group Ga and group Gb. Therefore, data on brain images of a plurality of examinees imaged by a predetermined method such as SPECT are mapped to a three-dimensional space as shown in FIG. 7(B) (in general, high-dimensional feature space, or sometimes infinite-dimensional space, Hilbert space) η so as to perform linear SVM in ii, so that nonlinear SVM can be realized. Since directly mapping data to the high-dimensional feature space η is difficult, analysis in the high-dimensional feature space η is realized using a method called kernel trick, as in the case of Embodiment 3.

Next, an algorithm of SVM is described. In linear SVM, it is investigated by a discriminant function shown in Equation 20 to which group (group Ga or group Gb) a piece of data on brain images is to be classified. As shown in FIG. 7(B), among data in each group (group Ga and group Gb), only data being closest to the other group contributes to building a decision surface 30. The data contributing to the building of the decision surface is called support vector 32.

$$\begin{matrix}[ Numerical formula 20 ] & \\ f ( x ) = {\sum }_{i = 1}^{n} {ω}_{i}^{T} {x}_{i} + b & ( 20 )\end{matrix}$$

Here, ω is a weight vector, and b is a bias term. N−1 dimensional hyperplane satisfying f(x)=0 becomes the decision surface. In order to evaluate this ω and this b, an objective function shown in Equation 21 is to be minimized.

$$\begin{matrix}[ Numerical formula 21 ] & \\ {min}_{ω , b , ɛ} \frac{1}{2} {‖ ω ‖}^{2} + C {\sum }_{i = 1}^{n} {ɛ}_{i} \\ where \\ {y}_{i} ( {ω}^{T} {x}_{i} + b ) ≧ 1 - {ɛ}_{i} , {ɛ}_{i} ≧ 0 & ( 21 )\end{matrix}$$

Here, yi is a label and has a value of 1 or −1. ε is a slack variable, which is a parameter for admitting misclassification to some extent when the two groups (group Ga and group Gb) cannot be separated by a hyperplane. C is a parameter showing to which extent misclassification is to be allowed, which is set experimentally at the use of SVM.

Alternatively, by using Lagrange's method of undetermined multipliers for Lagrange multiplier α, an objective function can be transformed as shown in Equation 22.

$$\begin{matrix}[ Numerical formula 22 ] & \\ {max}_{α } {\sum }_{i = 1}^{n} {α}_{i} - \frac{1}{2} {\sum }_{i , j = 1}^{n} {α}_{i} {α}_{j} {y}_{i} {y}_{i} {x}_{i}^{T} {x}_{j} \\ where \\ 0 ≦ {α}_{i} ≦ C \\ {\sum }_{i = 1}^{n} {α}_{i} {y}_{i} = 0 & ( 22 )\end{matrix}$$

In the nonlinear SVM, weight ω in the high-dimensional feature space η mapped by Φ is expressed by using a factor α as shown in Equation 23.

$$\begin{matrix}[ Numerical formula 23 ] & \\ ω = {\sum }_{i = 1}^{n} {α}_{i} {y}_{i} Φ ( {x}_{i} ) & ( 23 )\end{matrix}$$

The discriminant function is expressed as shown in Equation 24.

$$\begin{matrix}[ Numeical formula 24 ] & \\ \begin{matrix}f ( Φ ( x ) ) = {\sum }_{i = 1}^{n} {α}_{i} {y}_{i} {Φ ( x )}^{T} Φ ( {x}_{i} ) + b \\ = {\sum }_{i = 1}^{n} {α}_{i} {y}_{i} k ( x , {x}_{i} ) + b\end{matrix} & ( 24 )\end{matrix}$$

Here, the objective function is expressed as shown in Equation 25.

$$\begin{matrix}[ Numerical formula 25 ] & \\ {max}_{α} {\sum }_{i = 1}^{n} {α}_{i} - \frac{1}{2} {\sum }_{i , j = 1}^{n} {α}_{i} {α}_{j} {y}_{i} {y}_{j} k ( {x}_{i} , {x}_{j} ) \\ where \\ 0 ≦ {α}_{i} ≦ C {\sum }_{i = 1}^{n} {α}_{i} {y}_{i} = 0 & ( 25 )\end{matrix}$$

As a program for SVM, Gist2.2 (http://microarray.cpmc.columbia.edu/gist/index.html) was used, and a generally available Gaussian kernel was used as a kernel function.

As described above, in Embodiment 4 of the present invention, unlike in Embodiment 1 or the like, nonlinear SVM method was applied as a predetermined nonlinear multivariate analysis. In other words, data on brain images of a plurality of examinees imaged by a predetermined method such as SPECT are mapped to a high-dimensional feature space η by a kernel trick using a predetermined function so as to perform linear SVM is performed in η, so that nonlinear discrimination is performed.

As mentioned above, since classification is performed by applying a predetermined nonlinear multivariate analysis method in a case of Embodiment 4 like in Embodiment 1, it is possible to provide a brain-image diagnosis supporting method or the like which are a statistical evaluation method or the like excluding the subjective judgment of an examiner, and which enable image diagnosis. In addition, it is possible in discriminating difficult diseases to diagnose to present stable judgment criteria with respect to SPECT result of cerebral blood flow imaged by a predetermined method such as cerebral blood flow SPECT. As the method classifies data by applying a predetermined nonlinear multivariate analysis method, it is possible to provide an brain-image diagnosis supporting method or the like which are also effective with respect to relationships which can not be always explained with a simple linear relationship, for example, the relationship between SPECT images of cerebral blood flow imaged by a predetermined method such as cerebral blood flow SPECT and a disease which is a variable.

### Embodiment 5

In Embodiment 5, Kernel Fisher discriminant analysis method was applied as a predetermined nonlinear multivariate analysis. First, Kernel Fisher discriminant analysis method is described schematically.

Kernel Fisher discriminant analysis method is a nonlinear discriminant method with a teacher, and was proposed by S. Mika et al. in 1999 (“Frontier of Statistical Science 6: Statistics on Pattern Recognition and Learning”, by Hideki ASO et al., Iwanami Shoten (2003)), and S. Mika, G. R&auml;tsch, J. Weston, B. Sch&ouml;lkopf, and K. R. M&uuml;ller. Fisher discriminant analysis with kernels. Neural Networks for Signal Processing IX: 41-48: 1999, S. Mika, A. J. Smola, and B. Sch&ouml;lkopf: An improved training algorithm for kernel fisher discriminants. Proc. AISTATS: 98-104: 2001) Though the discriminant analysis is a classification method with a teacher like SVM, SVM uses a part of the support vectors close to a decision surface for building the decision surface, while Kernel Fisher discriminant analysis uses all data. Similarly as other methods using a kernel trick, this method also evaluates an inner product in the high-dimensional feature space by using a kernel function so as to perform linear discriminant analysis in the high-dimensional feature space η, so that nonlinear discriminant analysis can be performed.

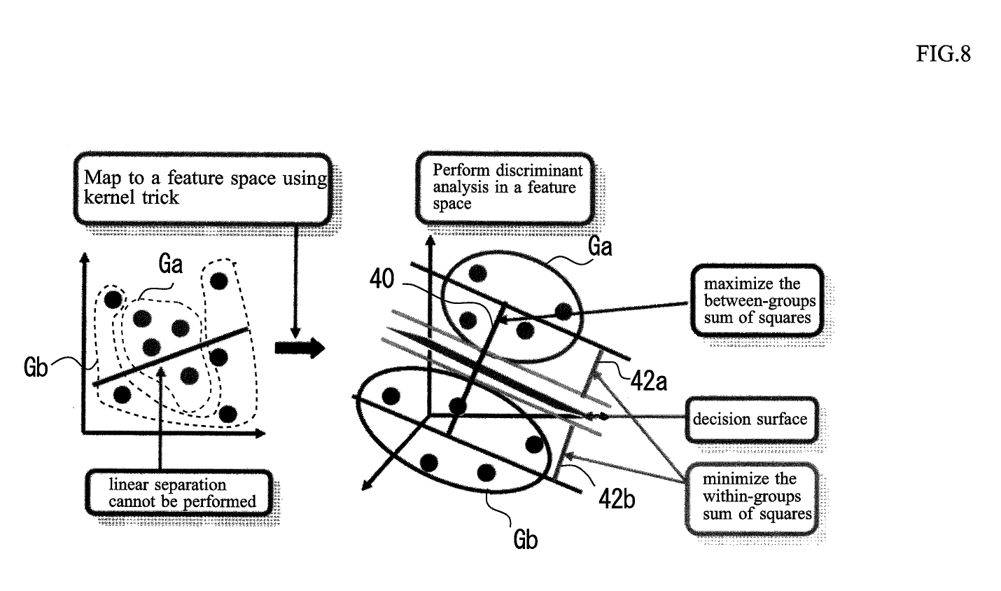

Next, it is explained how to apply nonlinear Kernel Fisher discriminant analysis to data on brain images of a plurality of examinees imaged by a predetermined method such as SPECT. FIG. 8 schematically shows Kernel Fisher discriminant analysis in Embodiment 5 according to the present invention. In a two-dimensional space shown in FIG. 8(A), linear separation (linear SVM) cannot be performed with respect to group Ga and group Gb. Therefore, data on brain images of a plurality of examinees imaged by a predetermined method such as SPECT are mapped to a three-dimensional space as shown in FIG. 8(B) (in general, high-dimensional feature space, or sometimes infinite-dimensional space, Hilbert space) η so as to perform Kernel Fisher discriminant analysis in η, so that nonlinear discriminant analysis can be realized. Since directly mapping data to the high-dimensional feature space η is difficult, analysis in the high-dimensional feature space η is realized using a method called kernel trick, as in the case of Embodiments 3 and 4.

Next, an algorithm of Kernel Fisher discriminant analysis method is described. In linear discriminant analysis, it is investigated by a discriminant function shown in Equation 26 to which group (group Ga or Gb) a piece of data is to be classified.

[Numerical formula 26]

q(x)=ω^{T}x (26)

For the weight vector ω in Equation 26, by maximizing an objective function J(ω) shown in Equation 27, the ratio between the between-groups sum of squares 40 (ω^{T}S_{B}ω) and within-groups sum of squares 42a and 42b (ω^{T}S_{W}ω) shown in FIG. 8(B) is to be maximum.

$$\begin{matrix}[ Numerical formula 27 ] & \\ J ( ω ) = \frac{{ω}^{T} {S}_{B} ω}{{ω}^{T} {S}_{W} ω} \\ {S}_{w ( within - group variance )} = {\sum }_{i = 1 , 2} \sum ( x - {m}_{i} ) {( x - {m}_{i} )}^{T} \\ {S}_{B ( between - group variance )} = ( {m}_{1} - {m}_{2} ) {( {m}_{1} - {m}_{2} )}^{T} \\ {m}_{i} = \frac{1}{{l}_{i}} {\sum }_{j = 1}^{li} {x}_{i , j} ( {l}_{i} \text{:} number of data in group i ) & ( 27 )\end{matrix}$$

In the Kernel Fisher discriminant analysis, weight ω in the high-dimensional feature space η mapped by Φ is expressed by using a factor α and a label y (=±1) as shown in Equation 28.

$$\begin{matrix}[ Numerical formula 28 ] & \\ ω = {\sum }_{i = 1}^{n} {α}_{i} {y}_{i} Φ ( {x}_{i} ) & ( 28 )\end{matrix}$$

The discriminant function can be expressed using a kernel matrix K and bias b as shown in Equation 29.

[Numerical formula 29]

q(x)=αK+b (29)

Here, the objective function to be maximized is expressed as shown in Equation 30.

$$\begin{matrix}[ Numerical formula 30 ] & \\ J ( α ) = \frac{{ω}^{T} {S}_{B}^{Φ} ω}{{ω}^{T} {S}_{W}^{Φ} ω} = \frac{{α}^{T} {M}_{α}}{{α}^{T} {N}_{α}} \\ {μ}_{k} = \frac{1}{\vert {I}_{k} \vert} {KI}_{k} \\ N = {KK}^{T} - {\sum }_{k = 1 , 2} \vert {I}_{k} \vert {μ}_{k} {μ}_{k}^{T} \\ M = ( {μ}_{2} - {μ}_{1} ) {( {μ}_{2} - {μ}_{1} )}^{T} & ( 30 )\end{matrix}$$

The objective function can be rewritten as shown in Equation 31, and can be discriminated by a probability value.

$$\begin{matrix}[ Numerical formula 31 ] & \\ {min}_{α , b , ɛ} {‖ ɛ ‖}^{2} + C \\ {\sum }_{i = 1}^{n} \vert {α}_{i} \vert \\ where \\ {K}_{α} + lb = y + ɛ \\ {\sum }_{j = 1}^{li} ɛ = 0 ( {l}_{i} \text{:} number of data in group i ) & ( 31 )\end{matrix}$$

In Equation 31, ε and b are slack variables, which are used as auxiliary means, and C is a parameter controlling the extent of regularization. Probability P that a certain piece of data on brain images belongs to a group (group Ga or Gb) can be expressed as shown in Equation 32.

$$\begin{matrix}[ Numerical formula 32 ] & \\ P ( y = \pm 1 \vert x ) = \frac{p ( x \vert y = \pm 1 ) P ( y = \pm 1 )}{\begin{matrix}p ( x \vert y = 1 ) P ( y = 1 ) + \\ p ( x \vert y = - 1 ) P ( y = - 1 )\end{matrix}} & ( 32 ) \\ where \\ p ( x \vert y = \pm 1 ) = \frac{1}{\sqrt{2 {πσ}_{\pm }^{2}}} exp ( - \frac{{( q ( x ) - {μ}_{\pm } )}^{2}}{2 {σ}_{\pm }^{2}} ) \\ {μ}_{\pm } = \pm 1 , {σ}_{\pm }^{2} = \frac{1}{{n}_{\pm } - 1} {\sum }_{{y}_{i} = \pm 1} {ɛ}_{i}^{2} , P ( y = \pm 1 ) = \frac{{n}_{\pm }}{n} & \end{matrix}$$

As a Kernel Fisher discriminant analysis program is a relatively new technique, the inventors themselves have prepared it. As a kernel function, a generally available Gaussian kernel was used.

As described above, in Embodiment 5 of the present invention, unlike in Embodiment 1 or the like, Kernel Fisher discriminant analysis was applied as a predetermined nonlinear multivariate analysis. Data on brain images of a plurality of examinees imaged by a predetermined method such as SPECT are mapped to a high-dimensional feature space η by a kernel trick using a predetermined function so as to perform linear discriminant analysis in the high-dimensional feature space η, so that nonlinear discrimination is performed. In linear discriminant analysis method, weight ω in a discriminant function used for classifying a piece of data on brain images into either of the groups (group Ga or Gb) is evaluated by maximizing an objective function J(ω) which can be expressed by the ratio between the between-groups sum of squares 40 (ω^{T}S_{B}ω) and within-groups sum of squares 42a and 42b (ω^{T}S_{W}ω). Alternatively, the above-mentioned objective function can be rewritten into a predetermined Equation such as Equation 31 so that discrimination is possible by a probability value p that a certain data on brain images belongs to a group (group Ga or Gb).

As mentioned above, since classification is performed by applying a predetermined nonlinear multivariate analysis method in a case of Embodiment 5 like in Embodiment 1 or the like, it is possible to provide a brain-image diagnosis supporting method or the like which are a statistical evaluation method or the like excluding the subjective judgment of an examiner, and which enable image diagnosis. In addition, it is possible in discriminating difficult diseases to diagnose to present stable judgment criteria with respect to SPECT result of cerebral blood flow imaged by a predetermined method such as cerebral blood flow SPECT. As the method classifies data by applying a predetermined nonlinear multivariate analysis method, it is possible to provide an brain-image diagnosis supporting method or the like which are also effective with respect to relationships which can not be always explained with a simple linear relationship, for example, the relationship between SPECT images of cerebral blood flow imaged by a predetermined method such as cerebral blood flow SPECT and a disease which is a variable.

### Embodiment 6

Each of the above-mentioned brain-image diagnosis supporting methods in Embodiments 1 through 5 can be configured as a brain-image diagnosis supporting program (computer program) to be executed by a computer so as to perform brain-image diagnosis support with respect to data on brain images. In other words, by making a computer to classify the data on brain images of a plurality of examinees imaged by a predetermined method such as SPECT, by applying predetermined nonlinear multivariate analysis methods described in Embodiments 1 through 5, a brain-image diagnosis supporting program for executing the image diagnosis support can be realized. Each of the flow charts and/or algorithms for brain-image diagnosis supporting methods described in Embodiments 1 through 5 can be used as a flow chart and/or an algorithm for each brain-image diagnosis supporting program.

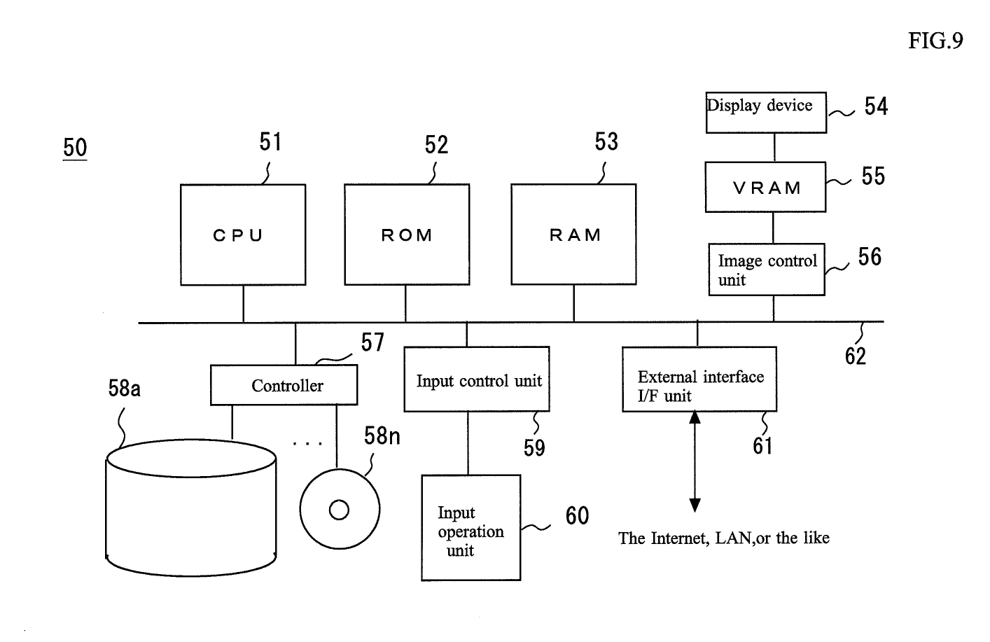

FIG. 9 is a block diagram showing an internal circuit 50 of the computer executing a brain-image diagnosis supporting program according to the present invention. As shown in FIG. 9, CPU 51, ROM 52, RAM 53, an image control unit 56, a controller 57, an input control unit 59 and an external interface (I/F) 61 are connected to bus 62. In FIG. 9, the above-mentioned computer programs according to the present invention are recorded in a recording medium (including detachable recording medium) such as ROM 52, disk 58a, or CD-ROM 58n. In the disk 58a, entered data on brain images of a plurality of examinees imaged by a predetermined methods such as SPECT can be recorded. The computer program is loaded from ROM 52 by way of the bus 62, or from the recording medium such as the disk 58a or CD-ROM 58n by way of the controller 57 and the bus 62 to RAM 53. The image control unit 56 transmits to VRAM 55 data for displaying the classified result, by applying the predetermined nonlinear multivariate analysis method to the data on brain images of a plurality of examinees imaged by a predetermined method such as SPECT which are stored in the disk 58a or the like. Display device 54 is a display or the like so as to display the classified results based on the above-mentioned data transmitted from VRAM 55. VRAM 55 is an image memory having a capacity corresponding to the data capacity per screen of the display device 54. An input operation unit 60 is an input device such as a mouse or a numeric keypad for input to the computer. The input control unit 59 is connected to the input operation unit 60 so as to control the input. External I/F 61 has an interface function which is for example used for connecting an (not shown) external communication network such as the Internet or LAN.

As mentioned above, executing a computer program of the present invention by the CPU 51 allows the objects of the present invention can be achieved. The computer program can be supplied to the computer CPU 51 by means of a recording medium such as CD-ROM 58n, as mentioned above, and thus a recording medium such as CD-ROM 58n which has recorded the computer program also constitutes the present invention as well. As a recording medium which records the computer program, other than the above-mentioned recording medium, a memory card, memory stick, DVD, optical disk, floppy disk or the like can be used for example.

### Embodiment 7

In Embodiments 1 through 5, application of each nonlinear multivariate analysis has been described. In the present Embodiment 7, application results to SPECT data of the cerebral blood flow is described.

The present invention in the present application was obviously made jointly by the inventors listed in the present application. Data used for the analysis, however, were measured in Tokushima University Hospital and provided by former DAIICHI RADIOISOTOPE LAB (present FUJIFILM RI PHARMA Co., Ltd.). Three-dimensional SPECT data on brain images after being converted to Talairach standard brain were used. As kinds of diseases, five kinds of diseases such as Alzheimer's disease (2 cases), dementia with Lewy body (4 cases), Huntington's Chorea (1 case), Parkinson's disease (19 cases), and progressive supranuclear palsy (2 cases) were dealt. Each disease was diagnosed by doctors in Tokushima University Hospital, though it should be noted that evaluation was performed at the time point of the diagnosis. As a radioactive agent, Iofetamine was used. Accumulation of Iofetamine achieves at its peak in the brain in 20 to 30 minutes after administration. Then its distribution in the brain varies depending on the time. Therefore, SPECT was measured for each case at 30 minutes and three hours after the agent administration.

1. Target Diseases

Table 1 shows symptoms and SPECT findings of cerebral blood flow for each disease. (M. J. Firbank, S. J. Colloby, D. J. Burn, I. G. McKeith, and J. T. O'Brien. Regional cerebral blood flow in Parkinson s disease with and without dementia. NeuroImage: 20: 1309-1319: 2003, Tsunehiko NISHIMURA, “Revised edition of clinical practice with latest brain SPECT/PET”, by MEDICAL VIEW CO., LTD. (2002))

TABLE 1

| Disease | Symptom | SPECT findings |
|---|---|---|
| Parkinson's disease | Thrill, rigidity | Hypoperfusion in frontal, parietal and temporal |
| | | regions |
| | Acinesis, slowed | Hypoperfusion similar in Lewy body disease in a case |
| | movement | of expressing dementia |
| Alzheimer's disease | Disorder of | Hypoperfusion in temporal and parietal association |
| | capacity to | areas |
| | register | |
| | Disorientation | Hypoperfusion in posterior cingulate gyrus |
| | Psychotic-like | Hypoperfusion in frontal cortex in advanced cases |
| | symptoms | |
| Dementia with | Unsteady | Hypoperfusion in temporal and parietal lobes |
| Lewy body | cognitive | |
| | function | |
| | Concrete optical | Hypoperfusion in occipital lobe |
| | illusion | |
| | Parkinsonism | Mildly hypoperfusion in the interior of temporal lobe. |
| Huntington's | Chorea-like | Hypoperfusion in basal ganglia |
| Chorea | involuntary | |
| | movement | |
| | Ruined mentality | Hypoperfusion in frontal cortex |
| | and intellect | |
| Progressive | Supranuclear | Hypoperfusion in basal ganglia |
| supranuclear palsy | vertical | |
| | ophthalmoplegia | |
| | Pseudobulbar | Hypoperfusion in frontal cortex, especially |
| | palsy | laterodorsal side |
| | Nucha dystonia | |

2. Selection of Input Data

It was also examined that all coordinate points of the Talairach standard brain would be standardized for each case with a mean of 0 and a variance of 1 for applying the various procedures. But it is considered that data not being characteristic of each disease will only cause noise. Therefore, input data are selected. In other words, from data on all imaged brain images on all lattice points, data on brain images on lattice points selected by a predetermined selection method are used as SPECT data on brain images. As for the predetermined selection method, though a method of only using data on clinically important coordinates where abnormal SPECT findings are observed can be used, a possibility that an important blood flow decreasing is caused in a region other than the region with known findings cannot be excluded, a more objective selection method for the input data is employed as far as possible.

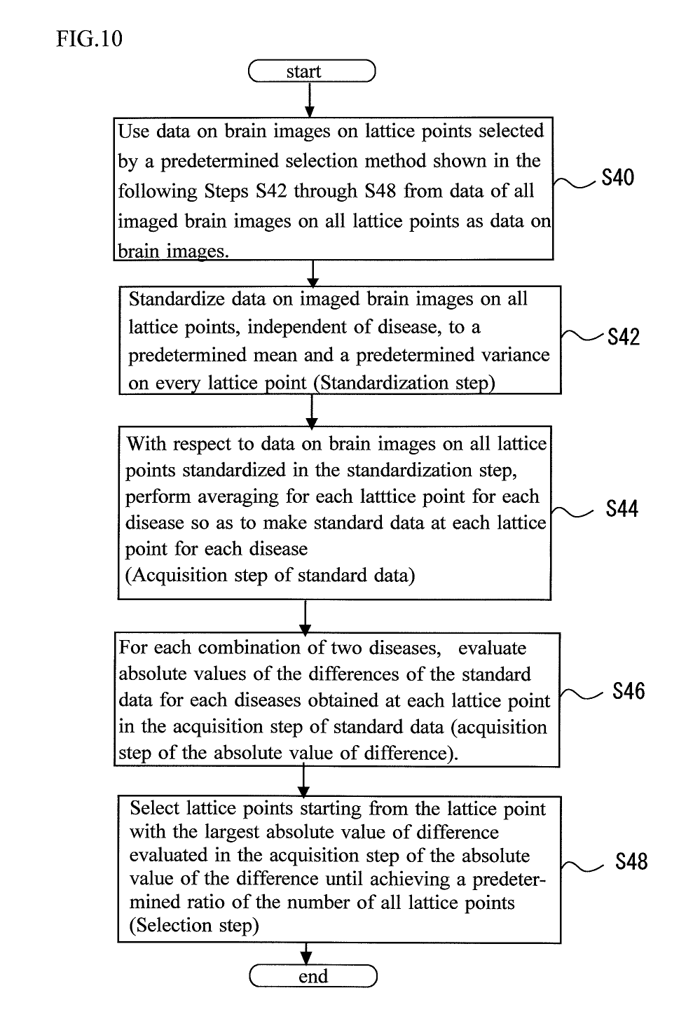

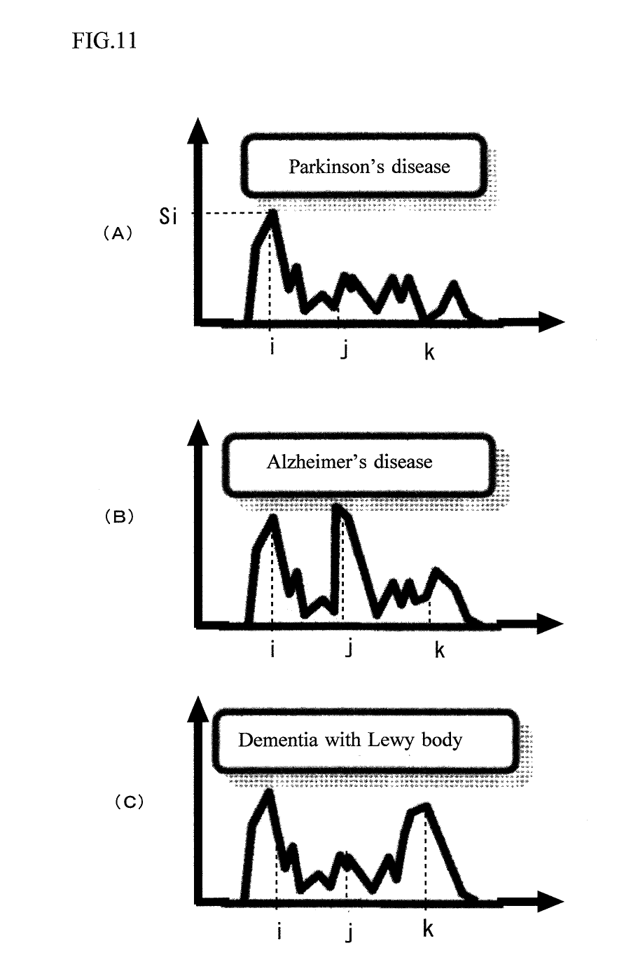

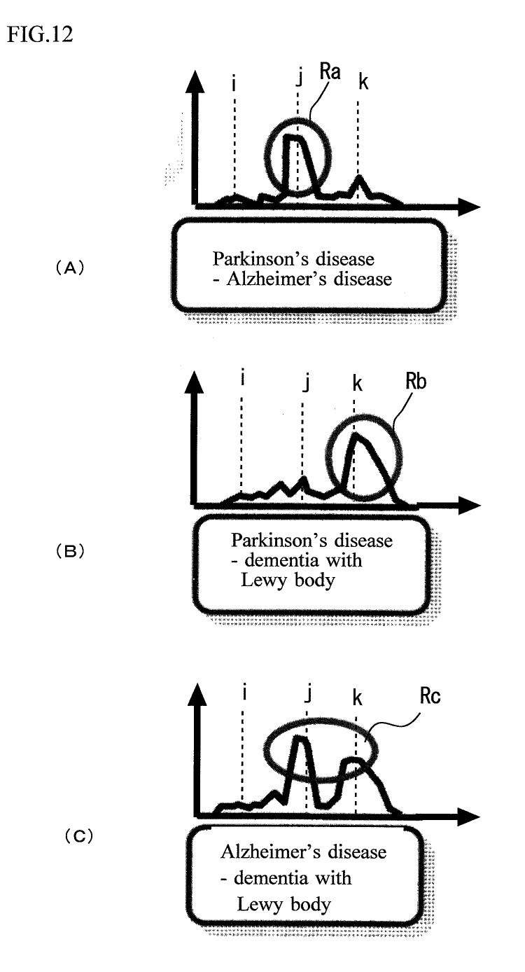

FIG. 10 is a flow-chart showing a flow of input data selection method in accordance with Embodiment 7 of the present invention. FIGS. 11 and 12 are schematic graphs for describing the input data selection method, where all lattice points (coordinate points) of the Talairach standard brain being numbered arbitrary are shown on the horizontal axis, and where SPECT data values on the cerebral blood flow and absolute values of SPECT data values on the cerebral blood flow (to be described below) are shown on the vertical axes of FIG. 11 and FIG. 12, respectively. As shown in FIG. 11(A), for example, SPECT data value on the cerebral blood flow at the lattice point i is Si. Hereinafter, the input data selection method is described in reference to FIGS. 10 through 12.

As shown in Step S40, SPECT data on brain images on lattice points selected by a predetermined selection method shown in the following Steps S42 through S48 from data of all imaged brain images on all lattice points are used as SPECT data on brain images.

First, SPECT data on imaged brain images on all lattice points is standardized, independent of disease, to a predetermined mean and a predetermined variance on every (three-dimensional) lattice point (Standardization step, Step S42). The predetermined mean is preferably 0, while the variance is preferably 1, though they are not limited to these values.

Next, with respect to SPECT data on brain images on all lattice points standardized in the standardization step (Step S42), averaging is performed for each lattice point for each disease so as to make standard (cerebral blood flow) data at each lattice point for each disease (Acquisition step of standard data, Step S44). In other words, SPECT data on brain images which are standardized in the standardization step (Step S42) (mean=0, variance=1 or the like) at all lattice points, independent of disease, are averaged in this acquisition step of standard data (Step S44) at all lattice points for each disease. FIG. 11(A) shows standard (cerebral blood flow) data (on vertical axis) averaged for each lattice point (horizontal axis) regarding Parkinson's disease. As shown in FIG. 11(A), standard (cerebral blood flow) data indicates Si, the maximum value, at the lattice point i, standard (cerebral blood flow) data indicates the second (or the like) peak value, which is smaller than Si at the lattice point j, and standard (cerebral blood flow) data indicates 0 at the lattice point k. FIG. 11(B) shows standard (cerebral blood flow) data (on vertical axis) averaged for each lattice point (horizontal axis) regarding Alzheimer's disease. As shown in FIG. 11(B), standard (cerebral blood flow) data indicates a similar value as Si, though not the maximum value, at the lattice point i, standard (cerebral blood flow) data indicates the maximum value at the lattice point j, and standard (cerebral blood flow) data indicates a value not being 0 at the lattice point k. FIG. 11(C) shows standard (cerebral blood flow) data (on vertical axis) averaged for each lattice point (horizontal axis) regarding dementia with Lewy body. As shown in FIG. 11(C), standard (cerebral blood flow) data indicates a slightly lower value than the maximum value at the lattice point i, standard (cerebral blood flow) data indicates a small peak value at the lattice point j, and standard (cerebral blood flow) data indicates a value after the maximum value at the lattice point k.

Subsequently, for each combination of two diseases, absolute values of the differences of the standard (cerebral blood flow) data for each diseases obtained at each lattice point in the acquisition step of standard data (Step S44) are evaluated (acquisition step of the absolute value of difference, Step S46).

FIG. 12(A) shows evaluated absolute values (vertical axis) of the differences between the standard (cerebral blood flow) data in a case of Parkinson's disease shown in FIG. 11(A) and the standard (cerebral blood flow) data in a case of Alzheimer's disease shown in FIG. 11(B). As shown in the FIGS. 11(A) and 11(B), each of the values for each disease at lattice point i indicates the maximum value or a value after the maximum value. Thus, when the absolute value of the difference of the two values is evaluated, it is an extremely small value, as shown in FIG. 12(A) (in the vertical axis). This shows that the lattice point i corresponds to a region where similar decrease in cerebral blood flow occurs in both diseases. On the other hand, as shown in FIGS. 11(A) and 11(B), a relatively small value is indicated at a lattice point j in a case of Parkinson's disease, while the maximum value is indicated at the same lattice point in a case of Alzheimer's disease. Thus, when the absolute value of the difference of the two values is evaluated, it nearly indicates the maximum value, as shown in FIG. 12(A) (in the vertical axis). This shows that the lattice point j corresponds to a region where dissimilar decrease in cerebral blood flow occurs in both diseases. As shown in FIGS. 11(A) and 11(B), a value of about 0 is indicated at a lattice point k in a case of Parkinson's disease, while a rather large value is indicated at the same lattice point in a case of Alzheimer's disease. Thus, when the absolute value of the difference of the two values is evaluated, it indicates a small peak value, as shown in FIG. 12(A) (in the vertical axis). This shows that the lattice point k corresponds to a region where a slight dissimilar decrease in cerebral blood flow occurs in both diseases. As shown in circle Ra in FIG. 12(A), the region where dissimilar decrease in cerebral blood flow occurs in both diseases is concentrated almost at one location.

FIG. 12(B) shows evaluated absolute values (vertical axis) of the differences between the standard (cerebral blood flow) data in a case of Parkinson's disease shown in FIG. 11(A) and the standard (cerebral blood flow) data in a case of dementia with Lewy body shown in FIG. 11(C). As shown in the FIGS. 11(A) and 11(C), each of the values for each disease at lattice point i indicates the maximum value or a value slightly smaller than the maximum value. Thus, when the absolute value of the difference of the two values is evaluated, it is an extremely small value, as shown in FIG. 12(B) (in the vertical axis). This shows that the lattice point i corresponds to a region where similar decrease in cerebral blood flow occurs in both diseases. On the other hand, as shown in FIGS. 11(A) and 11(C), a nearly similar value is indicated at a lattice point j in both diseases. Thus, when the absolute value of the difference of the two values is evaluated, it indicates a small value, as shown in FIG. 12(B) (in the vertical axis). This shows that the lattice point j corresponds to a region where similar decrease in cerebral blood flow occurs in both diseases. As shown in FIGS. 11(A) and 11(C), a value of about 0 is indicated at a lattice point k in a case of Parkinson's disease, while a value after the maximum value is indicated at the same lattice point in a case of dementia with Lewy body. Thus, when the absolute value of the difference of the two values is evaluated, it indicates nearly the maximum value, as shown in FIG. 12(B) (in the vertical axis). This shows that the lattice point k corresponds to a region where a dissimilar decrease in cerebral blood flow occurs in both diseases. As shown in circle Rb in FIG. 12(B), the region where dissimilar decrease in cerebral blood flow occurs in both diseases is concentrated almost at one location.

FIG. 12(C) shows evaluated absolute values (vertical axis) of the differences between the standard (cerebral blood flow) data in a case of Alzheimer's disease shown in FIG. 11(B) and the standard (cerebral blood flow) data in a case of dementia with Lewy body shown in FIG. 11(C). As shown in the FIGS. 11(B) and 11(C), each of the values for each disease at lattice point i indicates the maximum value or a value after the maximum value. Thus, when the absolute value of the difference of the two values is evaluated, it is an extremely small value, as shown in FIG. 12(C) (in the vertical axis). This shows that the lattice point i corresponds to a region where similar decrease in cerebral blood flow occurs in both diseases. On the other hand, as shown in FIGS. 11(B) and 11(C), the maximum value is indicated at the lattice point j in a case of Alzheimer's disease, while a relatively small value is indicated at the same lattice point in a case of dementia with Lewy body. Thus, when the absolute value of the difference of the two values is evaluated, it indicates the maximum value, as shown in FIG. 12(B) (in the vertical axis). This shows that the lattice point j corresponds to a region where dissimilar decrease in cerebral blood flow occurs in both diseases. As shown in FIGS. 11(B) and 11(C), a relatively small value is indicated at a lattice point k in a case of Alzheimer's disease, while a value after the maximum value is indicated at the same lattice point in a case of dementia with Lewy body. Thus, when the absolute value of the difference of the two values is evaluated, it indicates a peak value after the maximum value, as shown in FIG. 12(C) (in the vertical axis). This shows that the lattice point k corresponds to a region where a slight dissimilar decrease in cerebral blood flow occurs in both diseases. As shown in circle Rc in FIG. 12(C), the region where dissimilar decrease in cerebral blood flow occurs in both diseases is sometimes concentrated in two locations (or more).

Going back to FIG. 10, lattice points are selected starting from the lattice point with the largest absolute value of difference evaluated in the acquisition step of the absolute value of the difference (Step S46) until achieving a predetermined ratio of the number of all lattice points (Selection step, Step S48). As mentioned above, by evaluating absolute values of differences in standard (cerebral blood flow) data of the both diseases, regions where different status in decreasing the cerebral blood flow is shown for both diseases (lattice point, circle Ra or the like) can be found. Consequently, by starting to select regions (or lattice points) included in the circle Ra or the like, data of lattice points which can easily discriminate the both diseases can be selected as input data.

Standardized data in every coordinate point in the Talairach standard brain with a mean of 0 and a variance of 1 for each of the above-mentioned five cases were subject to the above-mentioned input data selection, and to the resulting data (hereinafter referred to as “selected coordinate 1”) the various methods in Embodiments 1 through 5 were applied. As a result, Huntington's Chorea and progressive supranuclear palsy, which have particularly different SPECT findings each other, can be classified relatively well. Next, with respect to only Alzheimer's disease, dementia with Lewy body and Parkinson's disease which were considered to be difficult in classification, standardized data in every coordinate point in the Talairach standard brain with a mean of 0 and a variance of 1 for each of the above-mentioned three cases were subject to the above-mentioned input data selection, and to the resulting data (hereinafter referred to as “selected coordinate 2”) the various methods in Embodiments 1 through 5 were applied. For both selected coordinates 1 and 2, the number of the lattice points selected as mentioned above (the number of selected coordinates) is set to account for about 10% (predetermined ratio of the number of all lattice points) of the entire coordinate number.

For SVM and Kernel Fisher discriminant analysis, which are supervised learning algorithm, classification should be performed in principle depending on disease. But since there are not many cases other than Parkinson's disease, so that classification in the present application was performed only between Parkinson's disease and other diseases. For SVM and Kernel Fisher discriminant analysis, validation was performed by way of Jackknife method. By Jackknife method, n−1 cases among n data cases are regarded as training data, while the remaining one case is regarded as a test data, and the all data are sequentially analyzed.

3. Parameters for Each Method

SOM utilizes som_pak3.1, and the parameters were set as shown in Table 2.

TABLE 2

| toporogy type | rect |
|---|---|
| Neighborhood type | gaussian |
| x-dimension | 20 |
| y-dimension | 20 |
| training length of first part (TL1) | 1000 |
| training rate of first part (TR1) | 0.05 |
| radius in first part (RD1) | 6 |
| training length of second part (TL2) | 5000 |
| training rate of second part (TR2) | 0.01 |
| radius in second part (RD2) | 2 |

In Table 2, “toporogy type” is a shape of a neighborhood of a winner neuron. “rect” means a rectangle. It may also be a hexagonal shape. “Neighborhood type” is a kind of neighborhood function, and “gaussian” means a function such as Gaussian kernel as in shown in Equation 13. Both “x-dimension” and “y-dimension” show sizes of the above-mentioned neighborhood, and they are 20×20 (rectangle). “Training length of the first part (TL1)” shows a the number of iteration (T) in a case of selected coordinate 1, and it is 1000. “Training rate of first part (TR1)” shows a velocity at which weight ω varies in a case of selected coordinate 1, which is 0.05 and is relatively slow. “Radius in first part (RD1)” is an initial value of the neighborhood in a case of selected coordinate 1, and it is 6. “Training length of first part (TL2)” shows a the number of iteration (T) in a case of selected coordinate 2, and it is 5000. “Training rate of first part (TR1)” shows a velocity at which weight ω varies in a case of selected coordinate 2, which is 0.01 and is relatively slow. “Radius in first part (RD2)” shows an initial value of the neighborhood in a case of selected coordinate 2, and it is 2. Fingerprint verification type SOM used the similar parameters. Proxscal of SPSS (trademark) 13.0.1 was used as a program for multidimensional scaling method.

Both Kernel principal component analysis and SVM used Gist2.2, which was applied after computing a kernel matrix in advance since the number of input data was large. A Gaussian kernel was used as a kernel function. As a parameter of Gist2.2, coefficient=1 was used. As a program for Kernel Fisher discriminant analysis, a program prepared by the author was used. As a kernel function, a Gaussian kernel was utilized.

Results

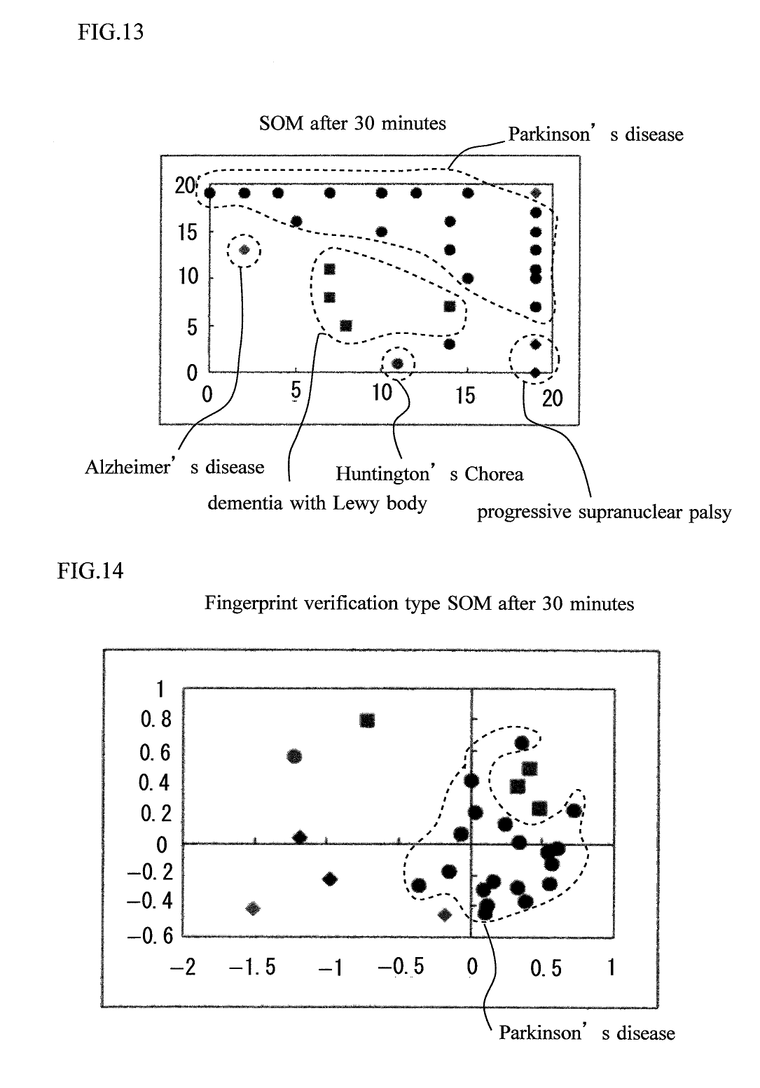

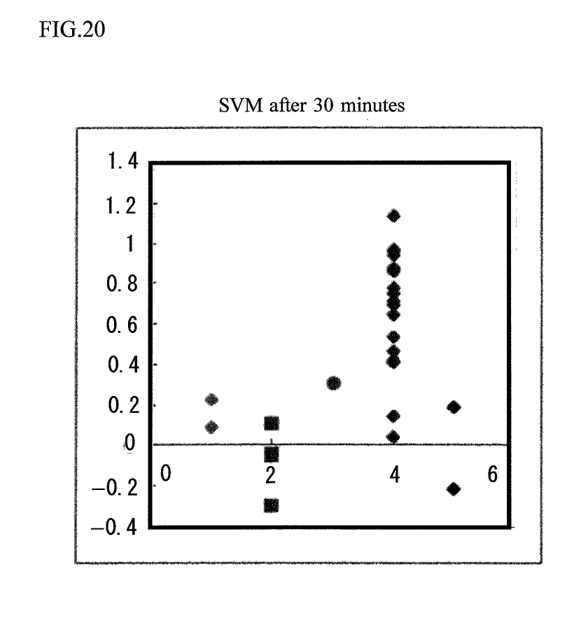

Hereinafter, first, results of the methods without a teacher (SOM, Fingerprint verification type SOM, and Kernel PCA) in the cases of selected coordinates 1 and 2 are shown in FIGS. 13 through 19. Next, results of the methods with a teacher (SVM and Kernel Fisher discriminant analysis) in the cases of selected coordinates 1 and 2 are shown in FIGS. 20 through 25. Regarding FIGS. 13 through 19, orange rhombus indicates a label for Alzheimer's disease in the original drawing, red rectangle indicates a label for dementia with Lewy body, blue circle indicates a label for Huntington's Chorea, brown circle indicates a label for Parkinson's disease, and violet rhombus indicates a label for progressive supranuclear palsy. But since labels are printed in black and white in the figures in the present application document, every label is distinguished literally only in FIG. 13 for the sake of convenience, and the labels in other FIGS. 14 through 25 are distinguished literally only in part. Each coordinate value in FIGS. 13 through 25 depends on a value of a function to be used, which is not so important, and distribution of the labels (classification result) is important.

Result of Methods without a Teacher.

Selected Coordinate 1 (SOM)

FIG. 13 shows a result of SOM when selected coordinate 1 was used. Elapsed time is 30 minutes. As shown in FIG. 13, Parkinson's disease, dementia with Lewy body, and progressive supranuclear palsy are classified well.

Selected Coordinate 1 (Fingerprint Verification Type SOM)

FIG. 14 shows a result of Fingerprint verification type SOM when selected coordinate 1 was used. Elapsed time is 30 minutes. As shown in FIG. 13, Parkinson's disease is classified well.

Selected Coordinate 1 (Kernel PCA)

FIG. 15 shows a result of Kernel PCA when selected coordinate 1 was used. Elapsed time is 30 minutes. As shown in FIG. 15, Parkinson's disease and progressive supranuclear palsy are classified well.

Selected Coordinate 1 (Kernel PCA)

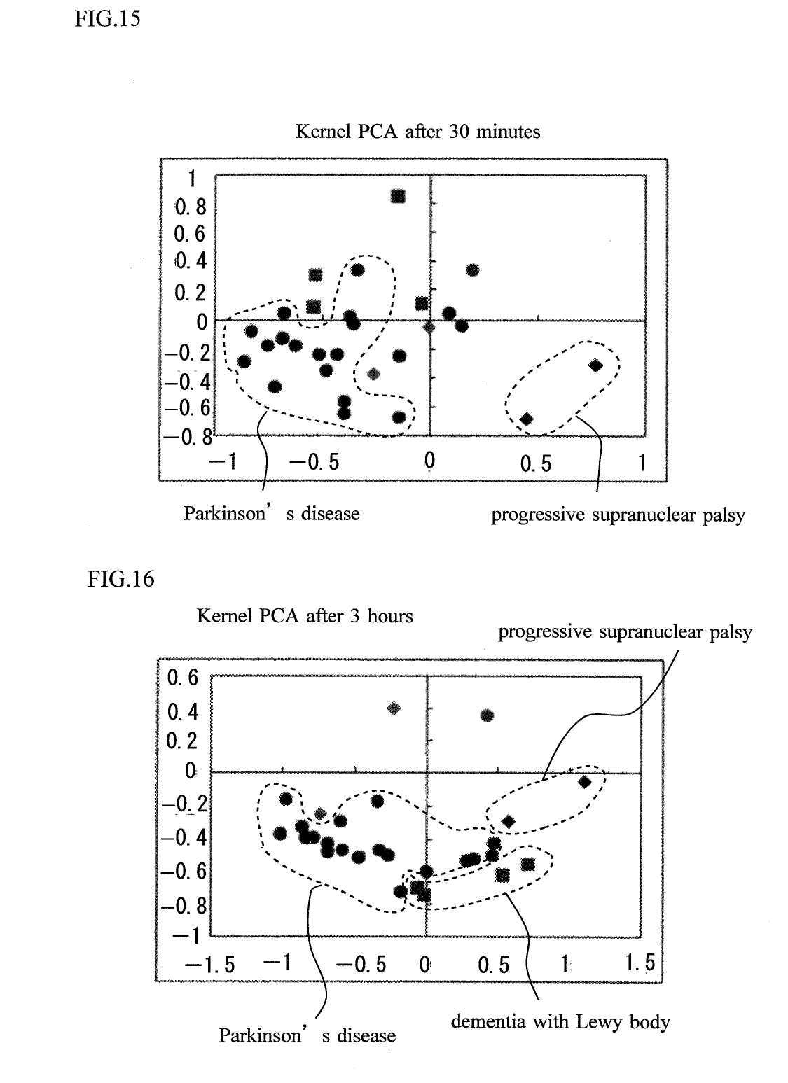

FIG. 16 shows a result of Kernel PCA when selected coordinate 1 was used. Elapsed time is three hours. Compared with FIG. 15, Parkinson's disease is classified better over time, and dementia with Lewy body is classified well over time.

Selected Coordinate 2 (SOM)

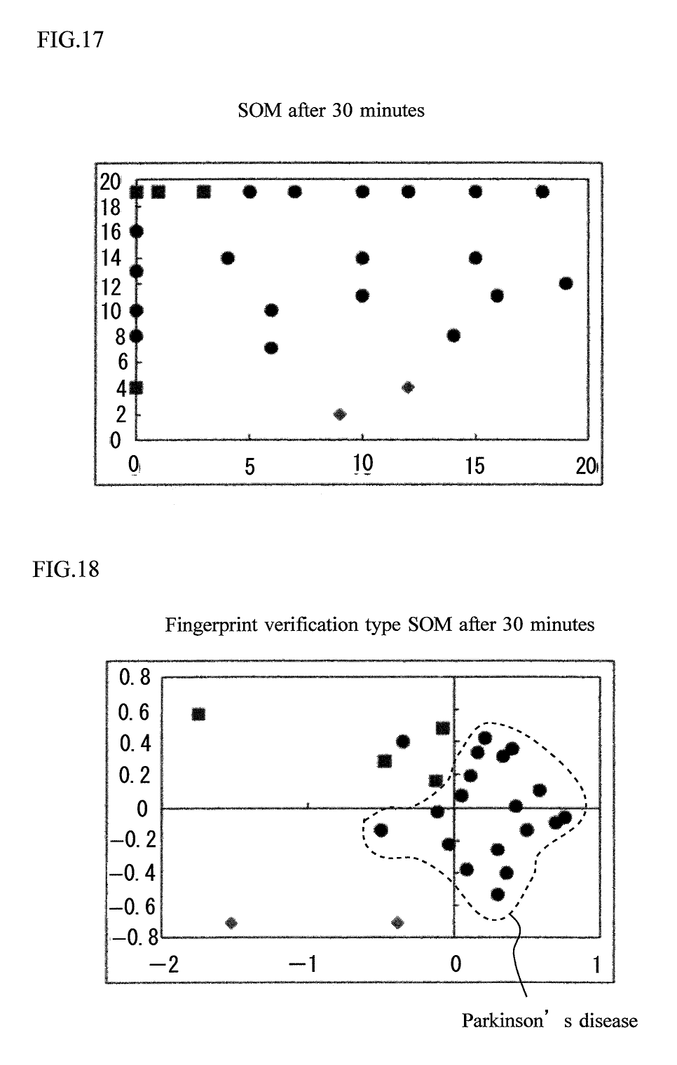

FIG. 17 shows a result of SOM when selected coordinate 2 was used. Elapsed time is 30 minutes.

Selected Coordinate 2 (Fingerprint Verification Type SOM)

FIG. 18 shows a result of Fingerprint verification type SOM when selected coordinate 2 was used. Elapsed time is 30 minutes. As shown in FIG. 18, Parkinson's disease is classified well.

Selected Coordinate 2 (Kernel PCA)

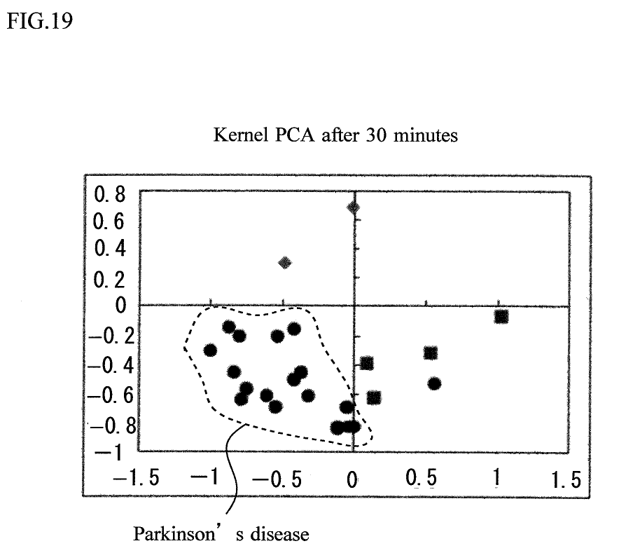

FIG. 19 shows a result of Kernel PCA when selected coordinate 2 was used. Elapsed time is 30 minutes. As shown in FIG. 19, Parkinson's disease is classified well.

Result of Methods with a Teacher.

Selected Coordinate 1 (SVM)

FIG. 20 shows a result of SVM when selected coordinate 1 was used. Elapsed time is 30 minutes. As shown in FIG. 20, each disease is classified well.

Selected Coordinate 1 (Kernel Fisher Discriminant Analysis)

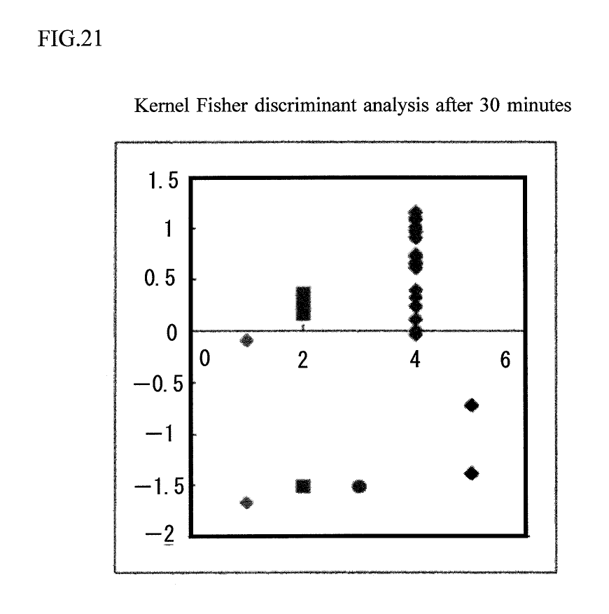

FIG. 21 shows a result of Kernel Fisher discriminant analysis when selected coordinate 1 was used. Elapsed time is 30 minutes. In FIG. 21, labels indicating 0 or larger in Kernel Fisher discriminant analysis are related to Parkinson's disease.

Selected Coordinate 1 (Kernel Fisher Discriminant Analysis)

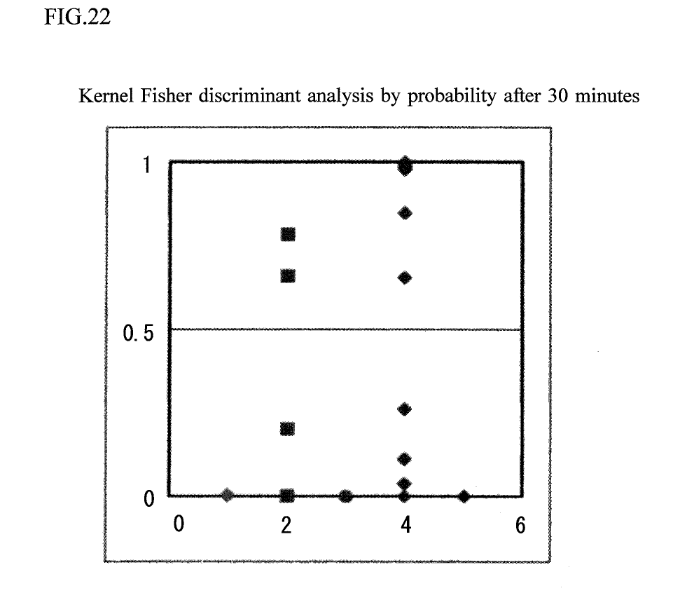

FIG. 22 shows a result of Kernel Fisher discriminant analysis when selected coordinate 1 was used. Elapsed time is 30 minutes. Unlike FIG. 21, this is an example that an objective function was rewritten (See Equation 32) so as to be able to discriminate by a probability that a certain data belongs to a disease. In FIG. 22, the probability in Kernel Fisher discriminant analysis which is 0.5 or more is related to Parkinson's disease.

Selected Coordinate 2 (SVM)

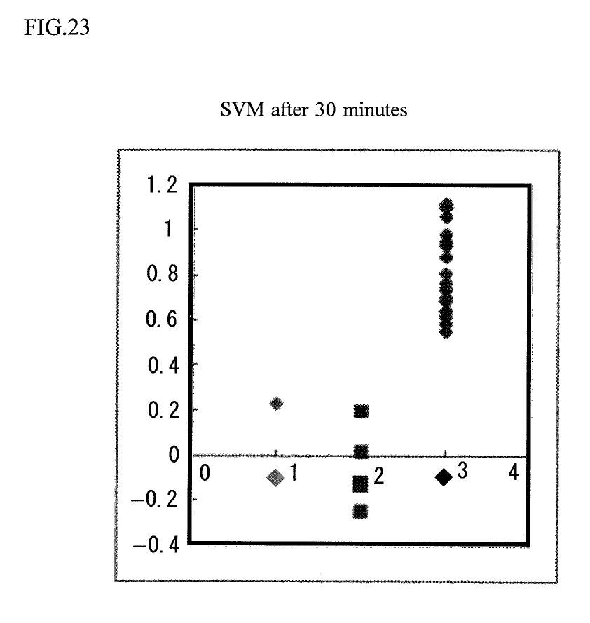

FIG. 23 shows a result of SVM when selected coordinate 2 was used. Elapsed time is 30 minutes. As shown in FIG. 23, each disease is classified well.

Selected Coordinate 2 (Kernel Fisher Discriminant Analysis)

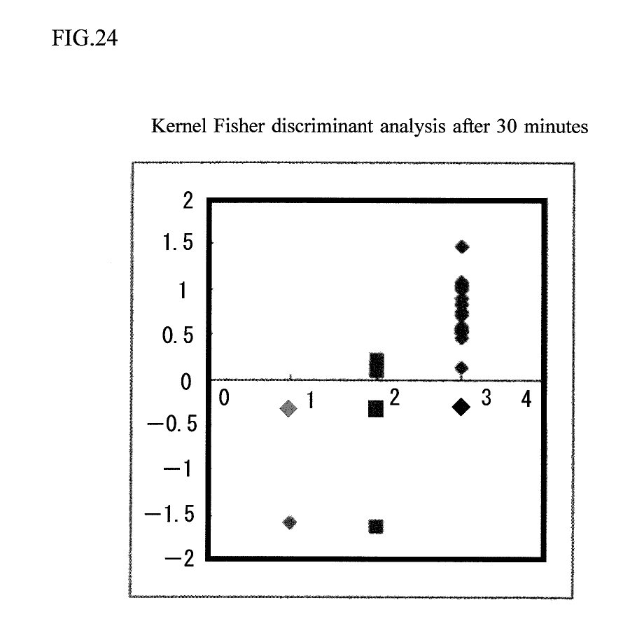

FIG. 24 shows a result of Kernel Fisher discriminant analysis when selected coordinate 2 was used. Elapsed time is 30 minutes. In FIG. 24, labels indicating 0 or larger in Kernel Fisher discriminant analysis are related to Parkinson's disease.

Selected Coordinate 2 (Kernel Fisher Discriminant Analysis)

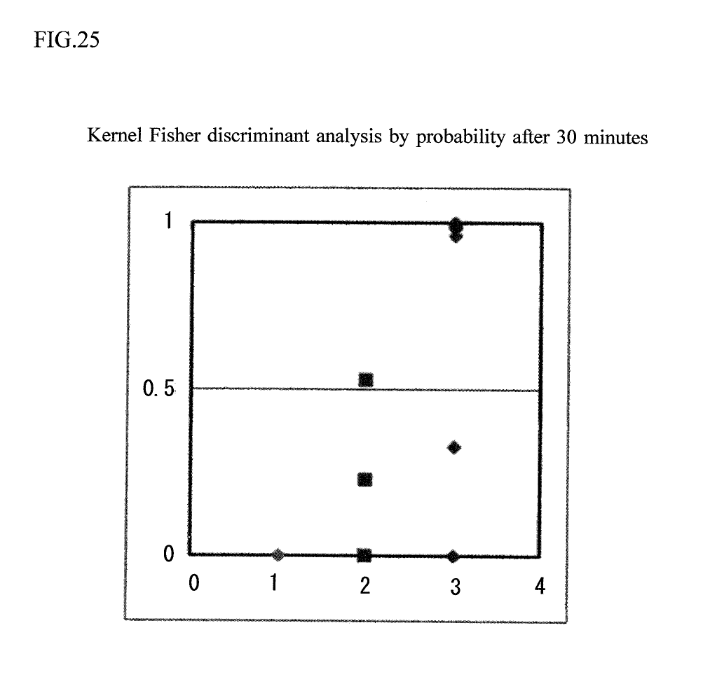

FIG. 25 shows a result of Kernel Fisher discriminant analysis when selected coordinate 2 was used. Elapsed time is 30 minutes. Unlike FIG. 24, this is an example that an objective function was rewritten (See Equation 32) so as to be able to discriminate by a probability that a certain data belongs to a disease. In FIG. 25, the probability in Kernel Fisher discriminant analysis which is 0.5 or more is related to Parkinson's disease.

As shown above, when an input data selection is adopted, Kernel principal component analysis and fingerprint verification type SOM among methods without a teacher allows good classification. This is considered to be caused because characteristic regions could be selected for each disease. Progressive supranuclear palsy and Huntington's Chorea can be classified well from the other diseases when selected coordinate 1 was used, because these diseases have different regions of decrease in blood flow in SPECT of the cerebral blood flow compared to other diseases. Even in the cases of Alzheimer's disease, dementia with Lewy body and Parkinson's disease, of which regions with decreased blood flow are relatively similar, a relatively good classification could be realized when selected coordinate 2 was used. For methods with teachers, it is considered that more cases are needed. Since methods without a teacher accomplishes classification to some extent, it is considered that with more cases for each disease, more proper decision surface can be set so as to realize better classification.

The results above show that the brain-image diagnosis supporting method or the like of the present invention are a statistical evaluation method or the like excluding the subjective judgment of an examiner, and enable image diagnosis. In addition, the results above also show that the brain-image diagnosis supporting method or the like of the present invention allow, in discriminating difficult diseases to diagnose (such as Alzheimer's disease, dementia with Lewy body and Parkinson's disease), to present stable judgment criteria with respect to SPECT result of cerebral blood flow imaged by cerebral blood flow SPECT, for example. Furthermore, the results above also show, that since the brain-image diagnosis supporting method or the like of the present invention classify data by applying a predetermined nonlinear multivariate analysis method, it is possible to provide an brain-image diagnosis supporting method or the like which are also effective with respect to relationships which can not be always explained with a simple linear relationship, for example, the relationship between SPECT images of cerebral blood flow imaged by cerebral blood flow SPECT and a disease which is a variable.

### Embodiment 8

In Embodiment 8, lattice values of the two-dimensional SOM in the fingerprint verification type SOM in the above-mentioned Embodiment 2 are described specifically. A lattice value of the two-dimensional SOM can be a distance with weight evaluated based on a predetermined distance between an input data vector and a reference vector. Hereinafter, a method for computing the distance with weight is described. Please note that symbols and suffixes used in Embodiment 8 sometimes differ from the ones used in the examples mentioned above.

1) Neural Network of Fingerprint Verification Type SOM

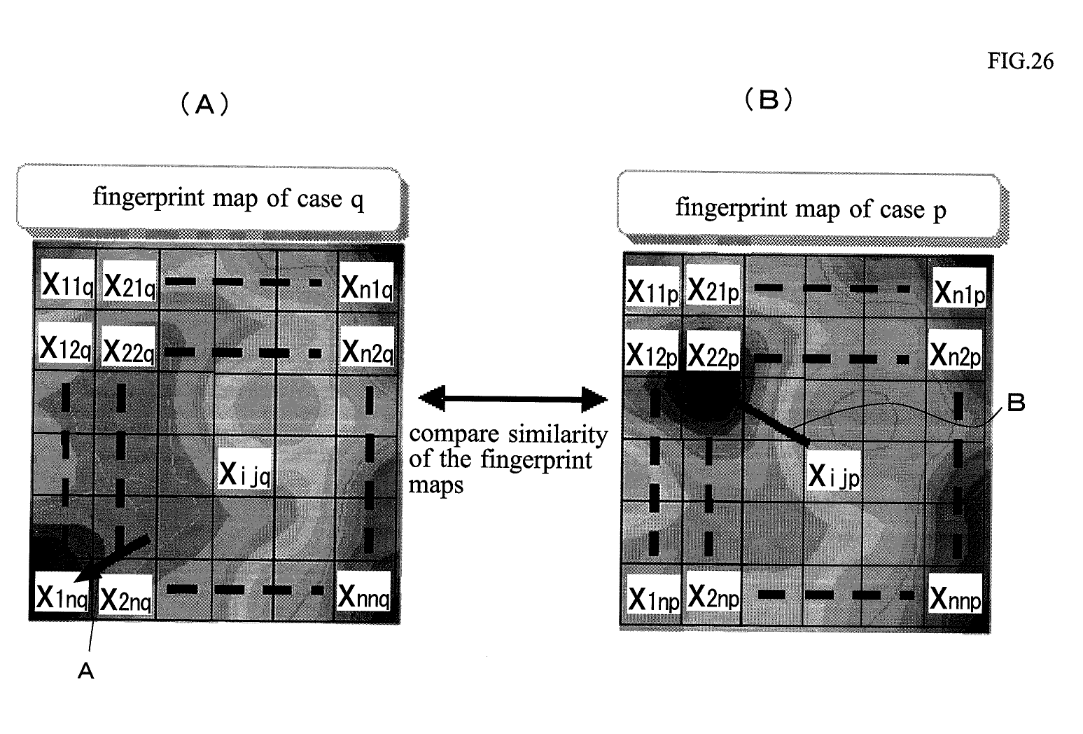

FIG. 26 shows a concept of fingerprint verification type SOM. Though a conventional SOM only employs locations of a winner neuron, i.e., locations with most red lattices in FIGS. 26(A) and 26(B) (shown with arrows A and B, respectively), this fingerprint verification type SOM also takes into account of the values of loser neurons (i.e. all other lattices than those shown with arrows A and B). The algorithm is as follows:

1. Distance zj,l(j=1, . . . , sxs, l=1, . . . , k) between sample data xl,i(l=1, . . . , k, i=l, . . . , h) and a lattice point vj,i(j=1, . . . , sxs, i=1, . . . , h) is computed. The sample data xl,i correspond to the sample input data vectors in the embodiments mentioned above, while lattice points vj,i correspond to SOM reference vectors. Unlike Embodiment 2, each of lattice points vj,i has a suffix j, which collectively handles two dimensions, and has a range of j=1, . . . , sxs. In other words, though number of lattices for each dimension is set to be n in Embodiment 2, is used for the notation in Embodiment 8.

Weight wj is applied as the first step weight when distance zj,l (a predetermined distance between the input data vector and the reference vector) is computed. Please note that this w is different from the reference vector mentioned in the embodiments above. For SOM reference vector, standard deviation is computed for each variable (each element of the reference vector). This standard deviation is a standard deviation calculated from the reference vector elements existing corresponding to a number of lattice points. When the standard deviation is upper a %, wj is set to be wj=1, and others are set to be wj=0, so that variables with a large standard deviation are used for preparing fingerprint mapping.

2. Furthermore, as the second step weight, ηj,l(j=1, . . . , sxs l=1, . . . , k) was applied. As shown in Equation 33, a mean Me of the distance zj, the maximum value zmax, and the minimum value zmin were evaluated for each case (for each sample data)

$$\begin{matrix}[ Numerical formula 33 ] & \\ {z}_{j , l} = \sqrt[n]{{\sum }_{i = 1}^{s \times s} {{η}_{j , l} ( {x}_{l , i} - {v}_{j , i} )}^{n}} & Equation 33\end{matrix}$$

Here, in Equations 34 and 35

Equation 34 and 35

[Numerical formula 34]

zⱼ*=(zⱼ−zₘᵢₙ)/(zₘₐₓ−zₘᵢₙ)

b=(Me−zₘᵢₙ)/(zₘₐₙₓ−zₘᵢₙ)×2a Equation 34 and 35

where a is an arbitrary positive input. The weigh ηj is as shown in Equation 36.

[Numerical formula 35]

ηⱼ=0.5{tan h(2azⱼ*−b)+1} Equation 36

Distance with weight yj at each lattice point for each case can be calculated as shown in Equation 37.

[Numerical formula 36]

yⱼ=ηⱼzⱼ(j=1, . . . , s×s) Equation 37

Fingerprint mapping is constituted by yj calculated above. This is applied to all cases so as to evaluate yj,l(j=1, . . . , sxs, l=1, . . . , k). The distance with weight Yj in Embodiment 8 corresponds to the output lattice value of SOM xijk(i, j=1, . . . , n) described in Embodiment 2.

3. Similarity (or dissimilarity) of the fingerprint maps prepared for each case is calculated based on a distance index such as Minkowski distance, so that a similarity matrix Vl,e is prepared as shown in Equation 38. The similarity matrix Vl,e is regarded to be a kind of distance matrix of Equation 2 in Embodiment 2.

$$\begin{matrix}[ Numerical formula 37 ] & \\ {V}_{l , e} = \sqrt[n]{{\sum }_{j = 1}^{s \times s} {( {y}_{j , l} - {y}_{j , e} )}^{n}} & Equation 38\end{matrix}$$

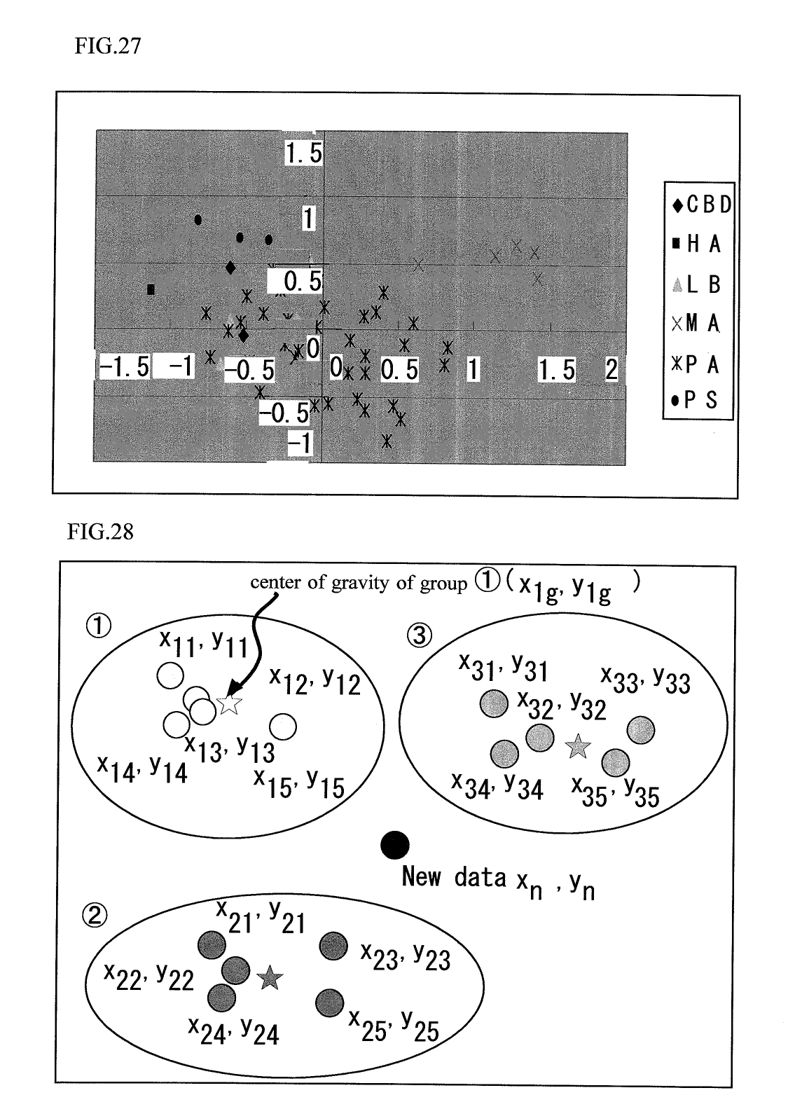

4. The similarity matrix is visualized by MDS (corresponding to the multidimensional scaling method in Embodiment 2). FIG. 27 shows an example of discrimination by fingerprint verification type SOM in Embodiment 8. In FIG. 27, CBD stands for corticobasal degeneration, HA Huntington's Chorea, LB dementia with Lewy body, MA spinocerebellar degeneration, PA Parkinson's disease, and PS progressive supranuclear palsy, respectively. As shown in FIG. 27, PS and MA are separated well each other.

2) Probabilistic Discrimination from Unsupervised Learning

In order to evaluate a probability that a new case belongs to each case group by fingerprint verification type SOM, a ratio of distances between the center of gravity of each known cases and a new case is considered to be a ratio of the probability. FIG. 28 is a view illustrating probabilistic discrimination from unsupervised learning. As shown in FIG. 28, whether a probability that a new case (new data xn, yn) belongs to the group 1, 2 or 3 is high or not is determined by a ratio of distances between the centers of gravity of the groups, which have been obtained from the known cases on the SOM map of fingerprint verification type, (where the gravity center of group 1 is shown with asterisk (x1g, y1g) and each of the centers of gravity of other groups is also shown with asterisk, respectively) and a piece of new data (New data xn, yn), i.e., a ratio P1:P2:P3 shown in Equation 39 which is related to each gravity center of each group.

[Numerical formula 38]

P₁:P₂:P₃=\sqrt{(x_{1g}−xₙ)²+(y_{1g}−yₙ)²}:\sqrt{(x_{2g}−x₂ₙ)²+(y_{2g}−yₙ)²}:\sqrt{(x_{3g}−xₙ)²+(y_{3g}−yₙ)²} Equation 39

Here, when a new case is to belong to some group, as shown in Equation 40,

Equation 40

[Numerical formula 39]

P₁:P₂:P₃=\sqrt{(x_{1g}−xₙ)²}:\sqrt{(x_{2g}−x₂ₙ)²+(y_{2g}−yₙ)²}:\sqrt{(x_{3g}−xₙ)²+(y_{3g}−yₙ)²}=d_{1g}:d_{2g}:d_{3g}

P₁+P₂+P₃=1 Equation 40

each probability can be calculated.

Though the present invention is thus described in reference to the above-mentioned Embodiments 1 through 8, the present invention is not limited to the constitutions shown in the above-mentioned Embodiments 1 through 8, and includes obviously each variation and modification pursuant to the principle of the present invention.

### INDUSTRIAL APPLICABILITY

As application examples of the present invention, the present invention can be applied to image diagnosis support with respect to data on brain images, imaged by SPECT or the like, of examinees suffering from degenerative neurological disorders such as Alzheimer's disease, dementia with Lewy body, Parkinson's disease, progressive supranuclear palsy and Huntington's Chorea.

1. A brain-image diagnosis supporting method using a computer performed with respect to data on brain images, wherein
Self-Organizing Map (SOM) method is applied to data on brain images of a plurality of examinees imaged by a predetermined method so as to classify said data for said image diagnosis support;
said data on brain images of the plurality of examinees imaged by said predetermined method are presented as input data vectors to neurons on a two-dimensional lattice array of the SOM method so as to perform image diagnosis support based on two-dimensional SOM after a predetermined training length;
regarding said SOM,
a measure to be minimum between said input data vector and a reference vector of each neuron is Euclidean distance; and
a neighborhood function which is used for learning said reference vector is a monotone decreasing function with respect to training length, which has a characteristic to converge on 0 with said training length being infinite, to monotonically decrease with respect to the Euclidean distance to a winner neuron, and to have an extent of said monotone decreasing being larger with the increase in training length.

2. A brain-image diagnosis supporting method according to claim 1, the method further comprises:
an acquisition step of all lattice values where values of all lattices of said two-dimensional SOM are evaluated for each learning by each input data vector;
a degree acquisition step where, based on all lattice values of said two-dimensional SOM for each input data vector evaluated in said acquisition step of all lattice values, a degree on similarity or dissimilarity between each of said input data vectors is evaluated; and
a constellation step where multidimensional scaling method is applied to said degree between each of said input data vector evaluated in said degree acquisition step so as to evaluate a point on a two-dimensional plane satisfying the degree between each of said input data vector.

3. A brain-image diagnosis supporting method according to claim 2, wherein said value of the lattice of said two-dimensional SOM is a distance with weight evaluated based on a predetermined distance between said input data vector and said reference vector.

4. A brain-image diagnosis supporting method using a computer performed with respect to data on brain images, wherein
Kernel principal component analysis (PCA) method is applied to data on brain images of a plurality of examinees imaged by a predetermined method so as to classify said data for image diagnosis support;
said data on brain images of the plurality of examinees imaged by said predetermined method are handled as an object to be analyzed for said Kernel PCA method;
said data are mapped to a high-dimensional feature space by means of a kernel trick using a predetermined kernel function; and
said data are subject to linear principal component analysis in said high-dimensional feature space so as to perform nonlinear principal component analysis.

5. A brain-image diagnosis supporting method using a computer performed with respect to data on brain images, wherein
nonlinear support vector machine (SVM) method is applied to data on brain images of a plurality of examinees imaged by a predetermined method so as to classify said data for image diagnosis support;
said data on brain images of the plurality of examinees imaged by said predetermined method are handled as an object to be analyzed for said nonlinear SVM method;
said data are mapped to a high-dimensional feature space by means of a kernel trick using a predetermined kernel function; and
said data are subject to linear SVM method in said high-dimensional feature space so as to perform nonlinear discrimination.

6. A brain-image diagnosis supporting method using a computer performed with respect to data on brain images, wherein
Kernel Fisher discriminant analysis method is applied to data on brain images of a plurality of examinees imaged by a predetermined method so as to classify said data for image diagnosis support;
said data on brain images of the plurality of examinees imaged by said predetermined method are handled as an object to be analyzed for Kernel Fisher discriminant analysis;
said data are mapped to a high-dimensional feature space by means of a kernel trick using a predetermined kernel function;
said data are subject to linear discriminant analysis in said high-dimensional feature space so as to perform nonlinear discrimination; and
in said linear discriminant analysis method, weight in a discriminant function used for classifying a piece of data in either of the groups is evaluated by maximizing an objective function expressed as a ratio between the between-groups sum of squares and within-groups sum of squares.

7. A brain-image diagnosis supporting method according to claim 6, wherein said objective function is rewritten in a predetermined Equation so as to allow discrimination with a probability that a piece of data belongs to a certain group.

8. A brain-image diagnosis supporting method according to any one of claims 4 through 7, wherein a Gaussian kernel or a polynomial kernel is used as said predetermined kernel function.

9. A brain-image diagnosis supporting method according to any one of claims 4 through 7, wherein as said brain-image data, data on brain image on lattice points which are selected by a predetermined selection method from data on all imaged brain images on all lattice points are used.

10. A brain-image diagnosis supporting method according to claim 9, wherein said predetermined selection method comprises:
a standardization step, where said data on imaged brain images on all lattice points is standardized, independent of disease, to a predetermined mean and predetermined variance on all lattice points;
an acquisition step of standard data, where with respect to said data on brain images on all lattice points standardized in said standardization step, averaging is performed for each lattice point for each disease so as to make standard data at each lattice point for each disease;
an acquisition step of the absolute value of difference, where for each combination of two diseases, absolute values of the differences of the standard data for each diseases obtained at each lattice point in said acquisition step of standard data are evaluated; and
a selection step, where lattice points are selected starting from the lattice point with the largest absolute value of difference evaluated in said acquisition step of the absolute value of difference until achieving a predetermined ratio of the number of all lattice points.

11. A brain-image diagnosis supporting method according to any one of claims 1, 4, 5, and 6, wherein said brain-image data are obtained from examinees suffering from degenerative neurological disorder as target group.

12. A brain-image diagnosis supporting method according to any one of claims 1, 4, 5, and 6, wherein said predetermined method for imaging said brain-image data is Single Photon Emission Computed Tomography (SPECT).

13. A brain-image diagnosis supporting program which allows a computer to perform a brain-image diagnosis support with respect to data on brain images, wherein
Self-Organizing Map (SOM) method is applied to data on brain images of a plurality of examinees imaged by a predetermined method so as to classify said data for said image diagnosis support;
said data on brain images of the plurality of examinees imaged by said predetermined method are presented as input data vectors to neurons on a two-dimensional lattice array of the SOM method so as to perform image diagnosis support based on two-dimensional SOM after a predetermined training length;
regarding said SOM,
a measure to be minimum between said input data vector and a reference vector of each neuron is Euclidean distance; and
a neighborhood function which is used for learning said reference vector is a monotone decreasing function with respect to training length, which has a characteristic to converge on 0 with said training length being infinite, to monotonically decrease with respect to the Euclidean distance to a winner neuron, and to have an extent of said monotone decreasing being larger with the increase in training length.

14. A brain-image diagnosis supporting program according to claim 13, the program further comprises:
an acquisition step of all lattice values where values of all lattices of said two-dimensional SOM are evaluated for each learning by each input data vector;
a degree acquisition step where, based on all lattice values of said two-dimensional SOM for each input data vector evaluated in said acquisition step of all lattice values, a degree on similarity or dissimilarity between each of said input data vectors is evaluated; and
a constellation step where multidimensional scaling method is applied to said degree between each of said input data vector evaluated in said degree acquisition step so as to evaluate a point on a two-dimensional plane satisfying the degree between each of said input data vector.

15. A brain-image diagnosis supporting program according to claim 14, wherein said value of the lattice of said two-dimensional SOM is a distance with weight evaluated based on a predetermined distance between said input data vector and said reference vector.

16. A brain-image diagnosis supporting program which allows a computer to perform a brain-image diagnosis support with respect to data on brain images, wherein
Kernel principal component analysis (PCA) method is applied to data on brain images of a plurality of examinees imaged by a predetermined method so as to classify said data for image diagnosis support;
said data on brain images of the plurality of examinees imaged by said predetermined method are handled as an object to be analyzed for said Kernel PCA method;
said data are mapped to a high-dimensional feature space by means of a kernel trick using a predetermined kernel function; and
said data are subject to linear principal component analysis in said high-dimensional feature space so as to perform nonlinear principal component analysis.

17. A brain-image diagnosis supporting program which allows a computer to perform a brain-image diagnosis support with respect to data on brain images, wherein
nonlinear support vector machine (SVM) method is applied to data on brain images of a plurality of examinees imaged by a predetermined method so as to classify said data for image diagnosis support;
said data on brain images of the plurality of examinees imaged by said predetermined method are handled as an object to be analyzed for said nonlinear SVM method;
said data are mapped to a high-dimensional feature space by means of a kernel trick using a predetermined kernel function; and
said data are subject to linear SVM method in said high-dimensional feature space so as to perform nonlinear discrimination.

18. A brain-image diagnosis supporting program which allows a computer to perform a brain-image diagnosis support with respect to data on brain images, wherein
Kernel Fisher discriminant analysis method is applied to data on brain images of a plurality of examinees imaged by a predetermined method so as to classify said data for image diagnosis support;
said data on brain images of the plurality of examinees imaged by said predetermined method are handled as an object to be analyzed for Kernel Fisher discriminant analysis;
said data are mapped to a high-dimensional feature space by means of a kernel trick using a predetermined kernel function;
said data are subject to linear discriminant analysis in said high-dimensional feature space so as to perform nonlinear discrimination; and
in said linear discriminant analysis method, weight in a discriminant function used for classifying a piece of data in either of the groups is evaluated by maximizing an objective function expressed as a ratio between the between-groups sum of squares and within-groups sum of squares.

19. A brain-image diagnosis supporting program according to claim 18, wherein said objective function is rewritten in a predetermined Equation so as to allow discrimination with a probability that a piece of data belongs to a certain group.

20. A brain-image diagnosis supporting program according to any one of claims 16 through 19, wherein a Gaussian kernel or a polynomial kernel is used as said predetermined kernel function.

21. A brain-image diagnosis supporting program according to any one of claims 16 through 19, wherein as said brain-image data, data on brain image on lattice points which are selected by a predetermined selection method from data on all imaged brain images on all lattice points are used.

22. A brain-image diagnosis supporting program according to claim 21, wherein said predetermined selection method comprises:
a standardization step, where said data on imaged brain images on all lattice points is standardized, independent of disease, to a predetermined mean and predetermined variance on all lattice points;
an acquisition step of standard data, where with respect to said data on brain images on all lattice points standardized in said standardization step, averaging is performed for each lattice point for each disease so as to make standard data at each lattice point for each disease;
an acquisition step of the absolute value of difference, where for each combination of two diseases, absolute values of the differences of the standard data for each diseases obtained at each lattice point in said acquisition step of standard data are evaluated; and
a selection step, where lattice points are selected starting from the lattice point with the largest absolute value of difference evaluated in said acquisition step of the absolute value of difference until achieving a predetermined ratio of the number of all lattice points.

23. A brain-image diagnosis supporting program according to any one of claims 13, 16, 17, and 18, wherein said brain-image data are obtained from examinees suffering from degenerative neurological disorder as target group.

24. A brain-image diagnosis supporting program according to any one of claims 13, 16, 17, and 18, wherein said predetermined method for imaging said brain-image data is Single Photon Emission Computed Tomography (SPECT).

25. A computer-readable recording medium that records the brain-image diagnosis supporting program according to any one of claims 13, 16, 17, and 18.
